(19) United States
(12) Patent Application Publication
(10) Pub. No.: US 2024/0039678 A1
(43) Pub. Date: Feb. 1, 2024

(54) SPECTRUM UTILIZATION IN TERRESTRIAL BROADCAST FOR LONG OFDM NUMEROLOGIES

(71) Applicant: QUALCOMM Incorporated, San Diego, CA (US)

(72) Inventors: Javier Rodriguez Fernandez, San Diego, CA (US); Ayan Sengupta, San Diego, CA (US); Alberto Rico Alvarino, San Diego, CA (US); Muhammad Sayed Khairy Abdelghaffar, San Jose, CA (US); Peter Gaal, San Diego, CA (US)

(21) Appl. No.: 17/816,711

(22) Filed: Aug. 1, 2022

(51) Int. Cl. H04L 5/00; H04L 27/26; H04W 72/04

(52) U.S. Cl. CPC H04L 5/0073; H04L 27/26025; H04L 5/0064; H04W 72/042; H04W 72/0453

(57) ABSTRACT

This disclosure provides systems, methods, and devices for wireless communication that support improved spectrum utilization, such as per band configuration of a maximum quantity of resource elements. In a first aspect, an apparatus for wireless communication includes at least one processor and a memory coupled to the at least one processor. The at least one processor is configured to receive scheduling information in accordance with a first maximum quantity of resources, wherein the first maximum quantity is based on a first channel bandwidth, first frequency band information, and a first subcarrier spacing (SCS), wherein the first frequency band information is indicative of a first type of frequency band or a first frequency band. The at least one processor is further configured to transmit or receive a first transmission in accordance with the scheduling information. Other aspects and features are also claimed and described.

### TECHNICAL FIELD

Aspects of the present disclosure relate generally to wireless communication systems, and more particularly, to spectrum utilization. Some features may enable and provide improved communications, including increased and more flexible resource allocation for improved spectrum utilization.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing the available network resources.

A wireless communication network may include several components. These components may include wireless communication devices, such as base stations (or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on a downlink to a UE or may receive data and control information on an uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure, an apparatus includes at least one processor and a memory coupled to the at least one processor. The at least one processor is configured to receive scheduling information in accordance with a first maximum quantity of resources, wherein the first maximum quantity is based on a first channel bandwidth, first frequency band information, and a first subcarrier spacing (SCS), wherein the first frequency band information is indicative of a first type of frequency band or a first frequency band; and transmit or receive a first transmission in accordance with the scheduling information.

In an additional aspect of the disclosure, a method for wireless communication includes receiving scheduling information in accordance with a first maximum quantity of resources, wherein the first maximum quantity is based on a first channel bandwidth, first frequency band information, and a first subcarrier spacing (SCS), wherein the first frequency band information is indicative of a first type of frequency band or a first frequency band; and transmitting or receiving a first transmission in accordance with the scheduling information.

In an additional aspect of the disclosure, an apparatus includes at least one processor and a memory coupled to the at least one processor. The at least one processor is configured to transmit scheduling information in accordance with a first maximum quantity of resources, wherein the first maximum quantity is based on a first channel bandwidth, first frequency band information, and a first subcarrier spacing (SCS), wherein the first frequency band information is indicative of a first type of frequency band or a first frequency band; and transmit or receive a first transmission in accordance with the scheduling information.

In another aspect of the disclosure, an apparatus includes at least one processor and a memory coupled to the at least one processor. The at least one processor is configured to receive scheduling information indicative of a first channel bandwidth, first frequency band information, a first subcarrier spacing (SCS), a starting resource, and a quantity of resources for a first transmission, wherein the first frequency band information is indicative of a first type of frequency band or a first frequency band; and transmit or receive, based on the starting resource and the quantity of resources, the first transmission in a set of resources of a first maximum quantity of resources, wherein the first maximum quantity of resources is based on the first channel bandwidth, the first frequency band information, and the first SCS.

In an additional aspect of the disclosure, a method for wireless communication includes receiving scheduling information indicative of a first channel bandwidth, first frequency band information, a first subcarrier spacing (SCS), a starting resource, and a quantity of resources for a first transmission, wherein the first frequency band information is indicative of a first type of frequency band or a first frequency band; and transmitting or receiving, based on the starting resource and the quantity of resources, the first transmission in a set of resources of a first maximum quantity of resources, wherein the first maximum quantity of resources is based on the first channel bandwidth, the first frequency band information, and the first SCS.

In an additional aspect of the disclosure, an apparatus includes at least one processor and a memory coupled to the at least one processor. The at least one processor is configured to transmit scheduling information indicative of a first channel bandwidth, first frequency band information, a first subcarrier spacing (SCS), a starting resource, and a quantity of resources for a first transmission, wherein the first frequency band information is indicative of a first type of frequency band or a first frequency band; and transmit or receive, based on the starting resource and the quantity of resources, the first transmission in a set of resources of a first maximum quantity of resources, wherein the first maximum quantity of resources is based on the first channel bandwidth, the first frequency band information, and the first SCS.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of an example wireless communication system according to one or more aspects.

FIG. 2 is a block diagram illustrating examples of a base station and a user equipment (UE) according to one or more aspects.

FIG. 3A is a diagram illustrating spectrum utilization and channel bandwidth.

FIG. 3B is a table illustrating configured channel bandwidths for combinations of band and subcarrier spacing (SCS).

FIG. 3C is a table illustrating a maximum resource block value for combinations of channel bandwidth and subcarrier spacing (SCS).

FIG. 4 is a block diagram illustrating an example wireless communication system that supports improved spectrum utilization according to one or more aspects.

FIG. 5 is a timing diagram illustrating an example process that supports improved spectrum utilization according to one or more aspects.

FIG. 6 is a timing diagram illustrating another example process that supports improved spectrum utilization according to one or more aspects.

FIG. 7 is a timing diagram illustrating another example process that supports improved spectrum utilization according to one or more aspects.

FIGS. 8A, 8B, and 8C each illustrate an example of a table of maximum transmission bandwidth configurations per band according to one or more aspects.

FIGS. 9A and 9B each illustrate an example of a table of maximum transmission bandwidth configurations per band according to one or more aspects.

FIGS. 10A and 10B each illustrate an example table of spectral utilization improvements according to one or more aspects.

FIGS. 11A and 11B each illustrate an example graph depicting spectral masks and spectral utilization according to one or more aspects.

FIG. 12 is a flow diagram illustrating an example process that supports improved spectrum utilization according to one or more aspects.

FIG. 13 is a flow diagram illustrating another example process that supports improved spectrum utilization according to one or more aspects.

FIG. 14 is a flow diagram illustrating another example process that supports improved spectrum utilization according to one or more aspects.

FIG. 15 is a flow diagram illustrating another example process that supports improved spectrum utilization according to one or more aspects.

FIG. 16 is a block diagram of an example UE that supports improved spectrum utilization according to one or more aspects.

FIG. 17 is a block diagram of an example base station that supports improved spectrum utilization according to one or more aspects.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support improved spectral utilization. The present disclosure provides band specific transmission bandwidth configuration (e.g., frequency band dependent maximum quantities of resource elements). The band specific transmission bandwidth configurations further enable use of different (e.g., smaller) SCS configuration and extension of cellular operations (e.g., LTE and/or 5G operations) to other spectrums, such as terrestrial broadcast spectrums (e.g., UHF, VHF, etc.).

Particular implementations of the subject matter described in this disclosure may be implemented to realize one or more of the following potential advantages or benefits. In some aspects, the present disclosure provides techniques for increased spectral occupancy and efficiency. Additionally, in some aspects, the present disclosure provides techniques for increased throughput and reduced latency. Furthermore, in some aspects, the present disclosure may enable use of smaller SCS and/or use of cellular operations in terrestrial broadcast spectrums. A resource element as used herein may include or correspond to a physical layer unit of bandwidth or transmission resources, and may include or correspond to a resource block, a number of resource blocks, or portion of a resource block (e.g., 12 REs to 1 RB).

This disclosure relates generally to providing or participating in authorized shared access between two or more wireless devices in one or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 millisecond (ms)), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc.

In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHz-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD or TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

The scalable numerology of 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

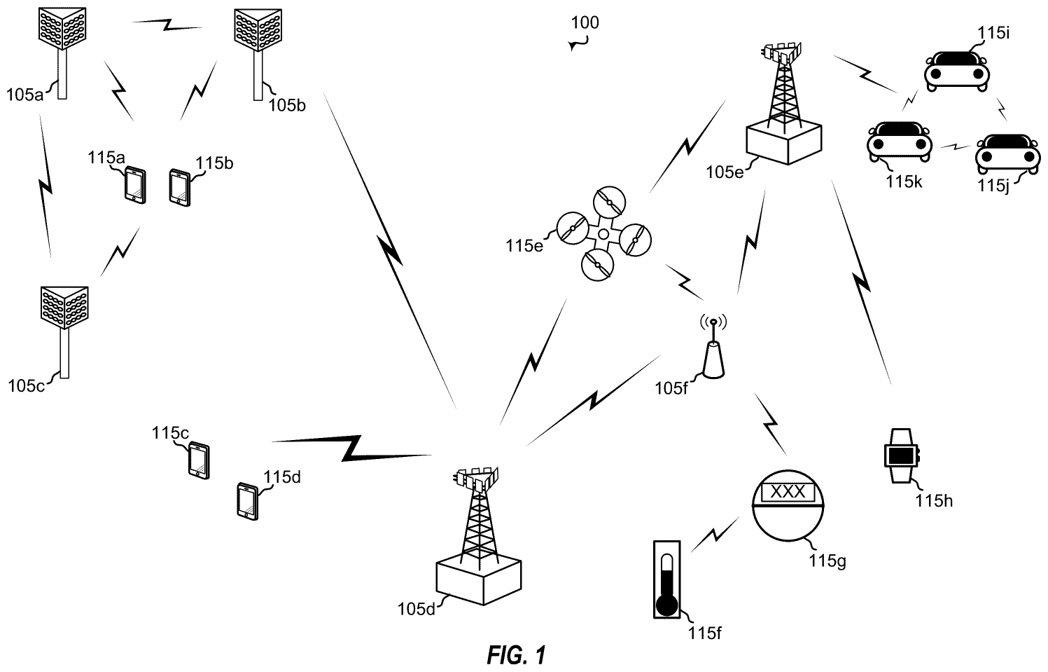

FIG. 1 is a block diagram illustrating details of an example wireless communication system according to one or more aspects. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100 A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105e.

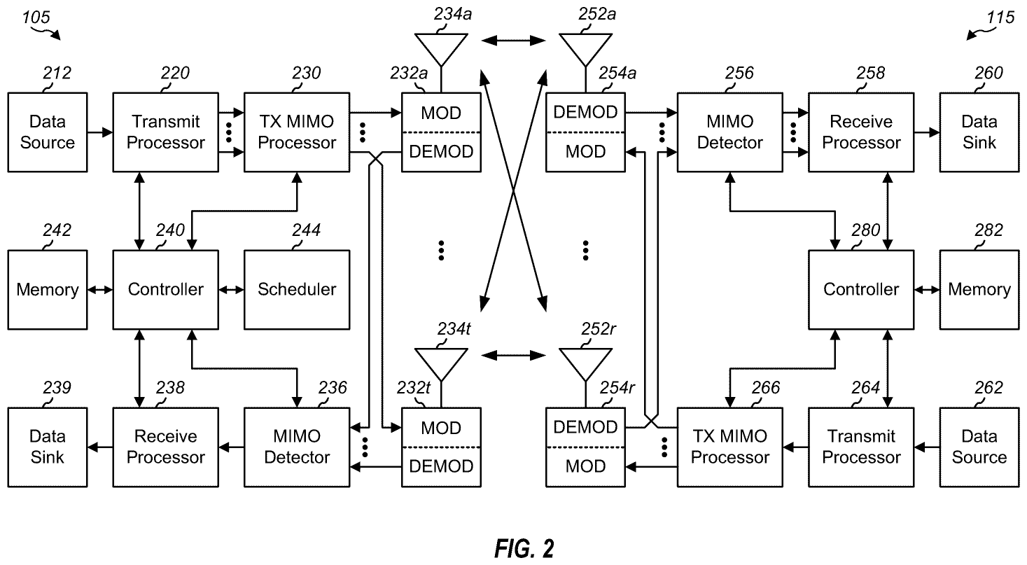

FIG. 2 is a block diagram illustrating examples of base station 105 and UE 115 according to one or more aspects. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115d operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

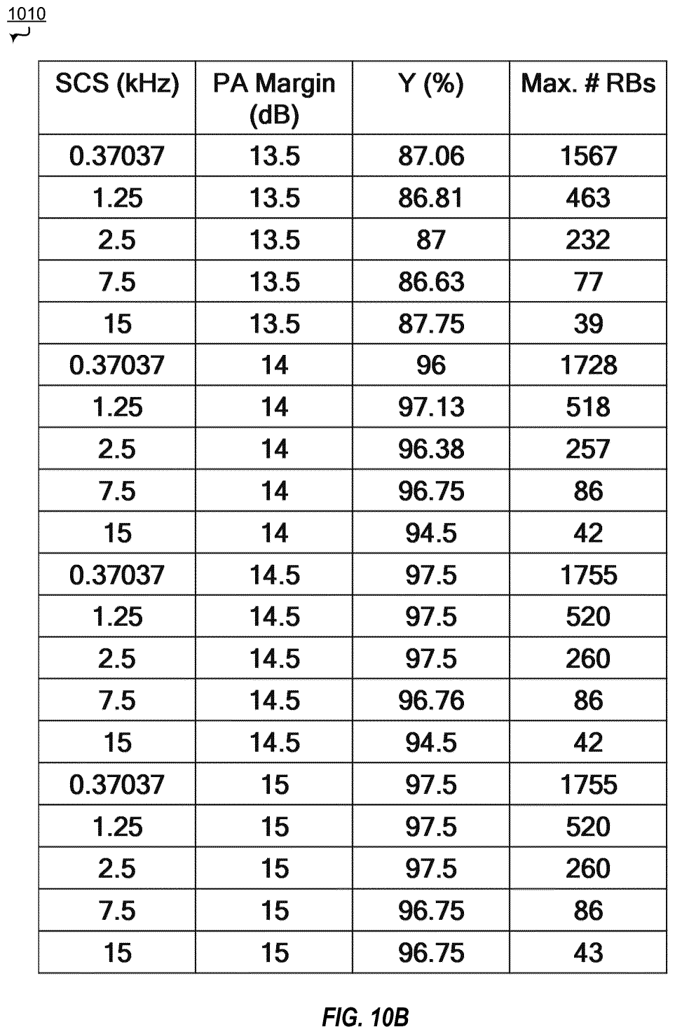

Controllers 240 and 280 may direct the operation at base station 105 and UE 115, respectively. Controller 240 or other processors and modules at base station 105 or controller 280 or other processors and modules at UE 115 may perform or direct the execution of various processes for the techniques described herein, such as to perform or direct the execution illustrated in FIGS. 12-15, or other processes for the techniques described herein. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

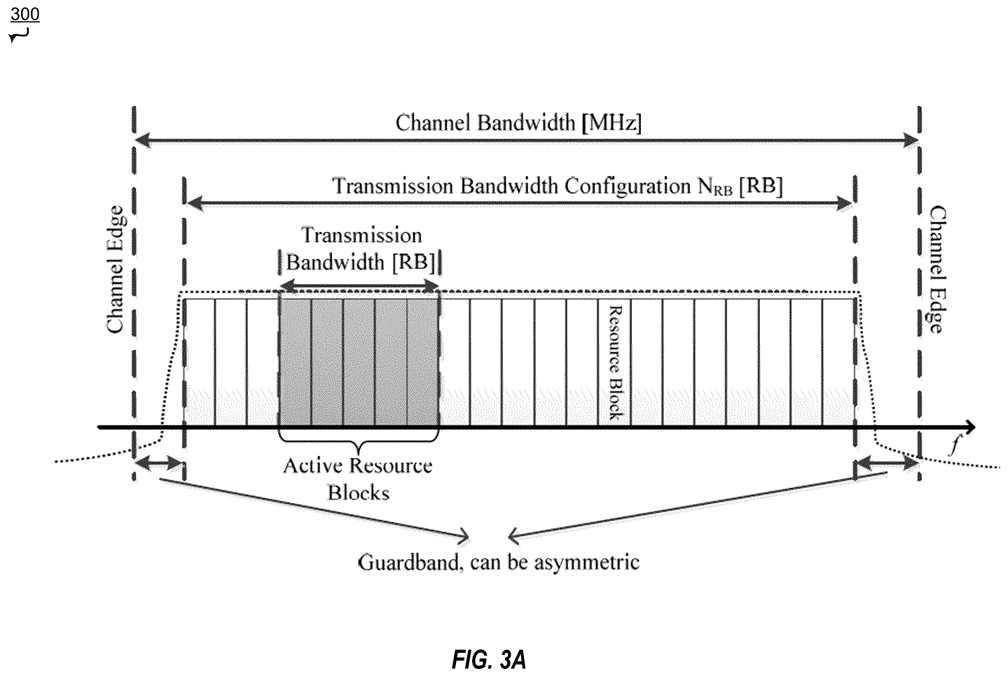

FIG. 3A illustrates a depiction of channel bandwidth. A diagram 300 of FIG. 3A depicts a relationship between the channel bandwidth (also referred to as UE channel bandwidth), a guardband, and a maximum transmission bandwidth configuration. The channel bandwidth is the bandwidth of a channel between channel edges. A channel may correspond to a particular portion of a frequency band of a frequency spectrum. A spectrum may have multiple bands, and each band may support one or more channels.

The one or more channels of the band may have the same size (bandwidth) or different sizes.

In order to reduce cross-channel interference, a guardband may be used between channels to provide a buffer between channels as illustrated in the diagram 300. The guardband may be set for a frequency spectrum and based on requirements or specifications thereof, such as shown by the dotted line for acceptable spectral leakage. The guardbands for a particular channel may be the same or different. As an example, asymmetrical (different guardbands) may be used between channels of different sizes or between bands of a frequency spectrum.

Based on the specifics of the guardbands for a particular channel, a certain portion of (e.g., left and right most portions outside of the resource blocks) of the channel bandwidth of the channel may not be available for transmission. These portions/resources may not be available for transmission because utilizing such frequency (and any corresponding resource blocks) may generate more interference than permitted and would interfere with communications in adjacent channels. Accordingly, based on a size of the guardband, a maximum quantity of transmission resources useable by the UE is less than the channel bandwidth. This maximum quantity of transmission resources is referred to as a transmission bandwidth configuration (N_{RB}). The transmission bandwidth configuration indicates a maximum quantity of resource blocks that can be assigned for the channel bandwidth. This maximum quantity of resource blocks that can be assigned for the channel bandwidth may be referred to as active resource blocks (as opposed to inactive resource blocks which correspond to the guardband).

The UE channel bandwidth may support a single NR component carrier (also referred to as just carrier) in uplink or downlink at the UE. From a network perspective, different UE channel bandwidths may be supported within the same spectrum for transmitting to and receiving from different UEs connected to the network (such as a specific cell or base station thereof). Transmission of or on multiple carriers to the same UE (carrier aggregation) or multiple carriers to different UEs within a base station's channel bandwidth can be supported.

From a UE perspective, the UE is configured with one or more bandwidth part (BWP) and/or carriers, each with its own UE channel bandwidth. The UE may not be aware of the base station's channel bandwidth or how the base station allocates bandwidth to different UEs. The placement of the UE channel bandwidth for each UE carrier is flexible and is completely within the BS channel bandwidth.

FIG. 3B illustrates a table 310 for UE channel bandwidths for each operating band (frequency band). The table 310 indicates valid or supported combinations of UE channel bandwidths, SCS, and frequency band. Specifically, the table 310 indicates which channel bandwidths are possible for a given combination of SCS and NR band by a ‘Y’ indicating Yes. The channel bandwidths specified may apply to both the transmit and receive paths (e.g., uplink and downlink). The channel bandwidths may also apply to sidelink.

In the example illustrated in FIG. 3B, the table 310 may include or correspond to a particular table, such as an uplink or UE side table. A separate table may be used for downlink or base station side transmissions. Bandwidths of a particular table and (e.g., DL) may be larger than bandwidths of another table (e.g., UL) in some implementations.

FIG. 3C illustrates a table 320 of maximum transmission bandwidth configurations. The table 320 includes a maximum transmission bandwidth configuration N_{RB} for each UE channel bandwidth and subcarrier spacing. Specifically, the table 320 indicates a maximum quantity of resource block that are possible for transmission or reception for a given combination of channel bandwidth and SCS. As illustrated in the table 320 of FIG. 3C, the maximum transmission bandwidth configuration (N_{RB}) is not directly based on or dependent on a frequency band. For example, NR bands n1 and n2 have the same maximum transmission bandwidth configuration (N_{RB}) for the same combination of channel bandwidth and SCS. To illustrate, for an SCS of 15 kHz and a channel bandwidth of 5 MHz, the NR bands n1 and n2 have the same maximum transmission bandwidth configuration (N_{RB}).

Often, a UE will be allocated and use only a portion of this maximum quantity of resource blocks, as shown in the diagram 300 of FIG. 3A. That is, the UE may be indicated a transmission bandwidth of a particular subset of resource blocks of the maximum quantity of resource blocks of the channel, such as by using a BWP or other indication of a quantity of resource blocks to use.

As an illustration, for each numerology, common resource blocks may be specified based on network, region, or standardized configurations. A starting point (e.g., starting resource block) of a transmission bandwidth configuration on the common resource block grid for a given channel bandwidth may be indicated by an offset, such as by an offset to a reference point in a unit of the numerology. As an illustrative example, the UE transmission bandwidth configuration information element (IE) is indicated by the higher layer parameter carrierBandwidth and will fulfill the minimum UE guardband requirement (and the resulting maximum transmission bandwidth configuration) for a particular combination of SCS and channel bandwidth.

Current wireless specifications, such as LTE, 5G, 5G NR, etc., require the same spectrum allocation (e.g., resource allocation such as the maximum quantity of useful REs, N_{RB}) for a given bandwidth (referred to as either channel or carrier bandwidth) across an entire frequency spectrum. The spectrum allocation is irrespective of the frequency band (also referred to as simply band) of the frequency spectrum. The frequency band, band, is often indicated by a band identifier, such as a band number (e.g., n1, n2, etc., for the frequency spectrum of FR1 of 5G NR). Additionally, the same spectrum allocation may be used across different frequency spectrums (e.g., LTE and 5G, FR1 and FR2, etc.). The maximum quantity of useful resource blocks (RBs) is also referred to as a transmission bandwidth configuration N_{RB}.

The only current dependency or variability in spectrum allocation for a particular cell bandwidth is dependent on the subcarrier spacing (SCS). That is, a particular frequency spectrum (also referred to as spectrum) will have a single spectrum allocation for all frequency bands of the frequency spectrum for each combination of channel bandwidth and SCS. For example, frequency bands n1 and n2 of FR1 have the same maximum allowable quantity of resource blocks for a first channel bandwidth (5 MHz) and a first SCS (15 kHz).

Previously, the transmission bandwidth configuration N_{RB} had no “band-specific flexibility” because the “spectral emission mask” (SEM) that is used for “cellular spectrum” is the same for all “cellular bands.” As the spectral mask was the same for each band, the resulting guardband and transmission bandwidth configuration N_{RB} (maximum quantity of resource blocks) did not very based on band.

A spectral efficiency mask (SEM) is basically set by “regulatory authorities”, and pertains to how much “out of band emissions (OOBE)” and/or “adjacent channel leakage ratio (ACLR)” are tolerable. The SEM may also be referred to or correspond to the guardband between the channel edge and the maximum transmission bandwidth configuration illustrated in FIG. 3A.

In the aspects described herein, a network may employ improved spectrum utilization schemes which enables the use of additional frequency spectrums, such as terrestrial broadcast spectrums, for cellular communications and enables increased usage (spectral occupancy) for bands of cellular and broadcast spectrums. In this disclosure, it is proposed to apply cellular (e.g., LTE and 5G) communications (e.g., communication standards and/or protocols) in other frequency spectrums, such as non-cellular frequency spectrums. As an illustrative, non-limiting example, a non-cellular frequency spectrum may include broadcast spectrums. In utilizing non-cellular frequency spectrums for cellular communications, the cellular (e.g., 5G) communications may be subject to different SEMs (different “out of band emissions (OOBE)” and/or “adjacent channel leakage ratio (ACLR)” requirements).

As an example, when extending 5G communications/operations to the UHF band (e.g., deploying Terrestrial Broadcast in UHF spectrum), which has a more stringent SEM, applying 5G configurations for such transmissions would violate the SEM and cause increased/non-compliant interference. Accordingly, additional configurations, such as the band specific maximum quantity of resources proposed herein, should be utilized to comply with more stringent SEMs and to provide additional bandwidth/throughput for less stringent SEMs. Additionally, using such band specific maximum quantity of resources may enable band specific SEMs to further enhance or optimize the quantity of channel bandwidth that can be used and reduce the size of the guardband or guardbands.

In addition, other frequency spectrums may have new (e.g., smaller) SCS values or extending 5G to other spectrums may enable new (e.g., smaller) SCS values. For example, extending 5G communications to broadcast spectrums, such as UHF, VHF, etc., enables SCS values smaller (e.g., 1.25 kHz) than those currently supported in 5G. In this disclosure, it is proposed to add additional band specific maximum transmission resource values for the SCS values of other spectrums (e.g., broadcast spectrums) for cellular transmissions.

As an illustration, the smaller the SCS, the (generally) higher attainable channel occupancy, and accordingly smaller guardbands. One exemplary reason for such is the difference in weighted overlap and add filtering (WOLA) length and decay rate to the decrease in SCS size and increase in FFT size. Additionally the larger the bandwidth generally increases occupancy percentage due to WOLA length. In some exemplary use cases, greater than 10 percent increases in spectral occupancy/efficiency can be obtained by using new band specific maximum resource values as compared to using legacy cellular (LTE/NR) non-band specific maximum resource values.

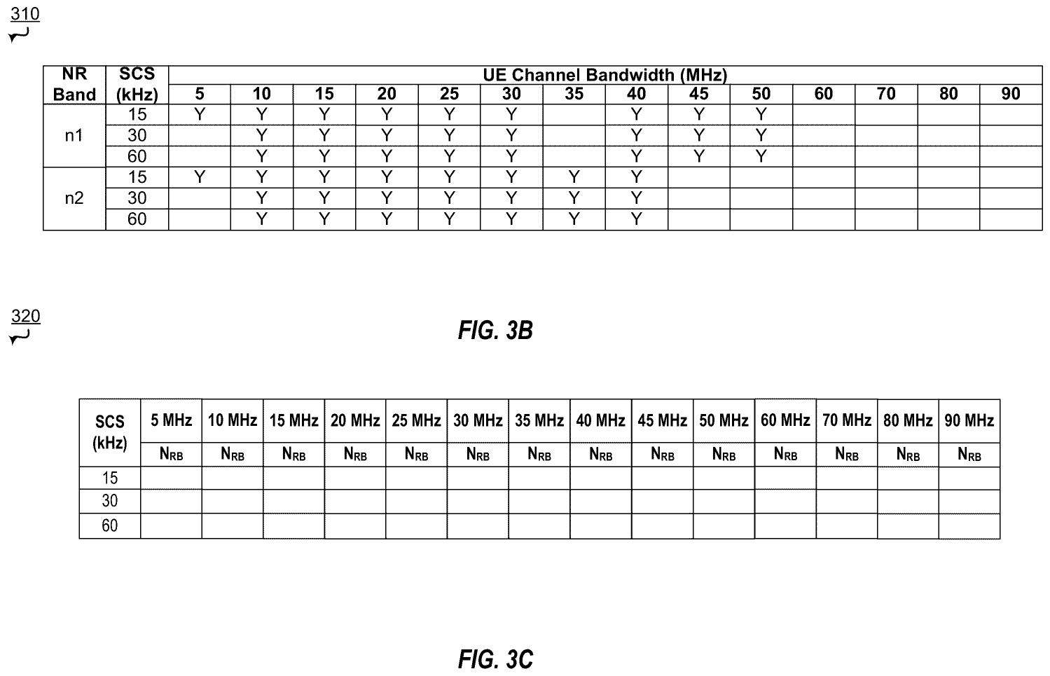

FIG. 4 illustrates an example of a wireless communications system 400 that supports improved spectrum utilization in accordance with aspects of the present disclosure. In some examples, wireless communications system 400 may implement aspects of wireless communication system 100. For example, wireless communications system 400 may include a network, such as one or more network entities, and one or more UEs, such as UE 115 (also referred to as a first UE) and second UE 403. As illustrated in the example of FIG. 4, the network entity includes a corresponds to a base station, such as base station 105. Alternatively, the network entity may include or correspond to a different network device (e.g., not a base station). Improved spectrum (or spectral) utilization operations may reduce latency and increase throughput. For example, utilizing a maximum quantity of resource elements based further on frequency band (a per band maximum quantity of resource elements) reduces latency and increases throughput by enabling larger transmissions (transmissions with more resource elements), reduced SCS, and extension of LTE and 5G to terrestrial broadcast spectrums. Accordingly, network and device performance can be increased.

Base station 105, UE 115, and second UE 403 may be configured to communicate via one or more portions of the electromagnetic spectrum. The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “mmWave” band in documents and articles, despite being different from the extremely high frequency (EHF) band (30 GHz-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

It is noted that SCS may be equal to 15, 30, 60, or 120 kHz for some data channels. Base station 105 and UE 115 may be configured to communicate via one or more component carriers (CCs), such as representative first CC 481, second CC 482, third CC 483, and fourth CC 484. Although four CCs are shown, this is for illustration only, more or fewer than four CCs may be used. One or more CCs may be used to communicate control channel transmissions, data channel transmissions, and/or sidelink channel transmissions.

Such transmissions may include a Physical Downlink Control Channel (PDCCH), a Physical Downlink Shared Channel (PDSCH), a Physical Uplink Control Channel (PUCCH), a Physical Uplink Shared Channel (PUSCH), a Physical Sidelink Control Channel (PSCCH), a Physical Sidelink Shared Channel (PSSCH), or a Physical Sidelink Feedback Channel (PSFCH). Such transmissions may be scheduled by aperiodic grants and/or periodic grants.

Each periodic grant may have a corresponding configuration, such as configuration parameters/settings. The periodic grant configuration may include configured grant (CG) configurations and settings. Additionally, or alternatively, one or more periodic grants (e.g., CGs thereof) may have or be assigned to a CC ID, such as intended CC ID.

Each CC may have a corresponding configuration, such as configuration parameters/settings. The configuration may include bandwidth, bandwidth part, HARQ process, TCI state, RS, control channel resources, data channel resources, or a combination thereof. Additionally, or alternatively, one or more CCs may have or be assigned to a Cell ID, a Bandwidth Part (BWP) ID, or both. The Cell ID may include a unique cell ID for the CC, a virtual Cell ID, or a particular Cell ID of a particular CC of the plurality of CCs. Additionally, or alternatively, one or more CCs may have or be assigned to a HARQ ID. Each CC may also have corresponding management functionalities, such as, beam management, BWP switching functionality, or both. In some implementations, two or more CCs are quasi co-located, such that the CCs have the same beam and/or same symbol.

In some implementations, control information may be communicated via base station 105, UE 115, and second UE 403. For example, the control information may be communicated suing MAC-CE transmissions, RRC transmissions, DCI (downlink control information) transmissions, UCI (uplink control information) transmissions, SCI (sidelink control information) transmissions, another transmission, or a combination thereof.

UE 115 can include a variety of components (e.g., structural, hardware components) used for carrying out one or more functions described herein. For example, these components can includes processor 402, memory 404, transmitter 410, receiver 412, encoder, 413, decoder 414, resource manager 415, spectrum manager 416, and antennas 252a-r. Processor 402 may be configured to execute instructions stored at memory 404 to perform the operations described herein. In some implementations, processor 402 includes or corresponds to controller/processor 280, and memory 404 includes or corresponds to memory 282. Memory 404 may also be configured to store resource information data 406, carrier information data 408, spectrum information data 442, settings data 444, or a combination thereof, as further described herein.

The resource information data 406 includes or corresponds to data associated with or corresponding to resources of the bandwidth allocated. For example, the resource information data 406 may include resource element data. The resource element data may include data on physical layer resource elements, such as resource blocks or groups thereof. The resource element data may include a starting resource element for a particular transmission and a quantity of resource elements (e.g., continuous or contiguous REs) for the particular transmission. In such implementations, the resource element data may be associated with or referred to as resource information or timing information. For example, a single indicator (e.g., a resource indicator value (RIV) or start and length indicator value (SLIV)) may be used to indicate both a starting resource element (RE) (or RB) and a quantity (e.g. number or amount) of resource elements (or RBs). In other examples, the resource element data may include a number of RE groups (or RB groups (RBGs)) and/or an identification of RBGs (such as by an offset from a reference or core RBG).

Additionally, or alternatively, the resource information data 406 may include resource configuration data. The resource configuration data may include or correspond to values identifying or indicating a maximum quantity of resources for a particular set of parameters. For example, the resource configuration data may correspond to a data structure (e.g., table, list, matrix, etc.) which includes transmission bandwidth configurations, such as a maximum quantity of resource blocks per channel bandwidth. The resource configuration data may include a unique or dedicated value for each combination of channel bandwidth, SCS, and frequency band. That is the resource configuration data may include band specific quantities of maximums resource elements. The resource information data 406 may include data received from the network (e.g., base station 105) and/or programmed into the memory 404. The resource information data 406 may be configured by RRC and/or modified by MAC-CE, DCI and/or other control signaling (e.g., broadcast spectrum control signaling).

The carrier information data 408 includes or corresponds to data associated with or corresponding to carrier configurations. For example, the carrier information data 408 may include carrier configurations information. The carrier configurations information may include information for one or more settings or parameters of a component carrier, channel, and/or cell. For example, the carrier configurations information may include channel bandwidth information, frequency band information, SCS information, bandwidth part information, etc.

The spectrum information data 442 includes or corresponds to data indicating or corresponding to spectrum allocations and/or configuration. For example, the spectrum information data 442 may include or correspond to spectrum configuration data. The spectrum configuration data may include configuration information for different frequency spectrums. For example, the spectrum configuration data may include a maximum quantity of resource elements for a particular spectrum or band thereof, a particular OOBE value for a particular spectrum or band thereof, a particular SEM value for a particular spectrum or band thereof, or a combination thereof.

Scheduling information may be in accordance with a maximum quantity of resources for a particular band or with multiple maximum quantities of resources for multiple bands, where each maximum quantity is associated with a different band.

Scheduling information may include or be indicative of one or more pieces of information used to schedule a particular transmission or transmissions. For example, scheduling information may include or be indicative of channel bandwidth information, SCS information, frequency band information, spectrum information, starting resource information, quantity of resource information (e.g., a quantity/number of consecutive resource elements).

Scheduling information may include one or more component pieces of information. In a particular example, scheduling information includes configuration information (e.g., channel configuration information) and timing information. In another particular example, scheduling information includes resource configuration information and timing information.

The settings data 444 includes or corresponds to data associated with improved spectrum utilization operations. The settings data 444 may include one or more types of improved spectrum utilization operation modes and/or thresholds or conditions for switching between improved spectrum utilization modes and/or configurations thereof. For example, the settings data 444 may have data indicating different thresholds and/or conditions for different improved spectrum utilization modes, such as a prediction mode, a measurement only mode, a relay mode, etc., or a combination thereof. As another example, the settings data 444 may include thresholds and/or conditions for determining a predicted blockage, determining when to send measurement data, determining when to send a predicted blockage, etc. In some implementations, the settings data 444 may include one or more pathloss conditions for determining when to send a predicted beam blockage message.

Additionally, or alternatively, the settings data 444 may include UE capabilities information, such as transmit power information, battery power information, prediction capability information, relay capability information, etc. The UE capabilities information may be transmitted to another UE and/or network device to enable configuration of improved spectrum utilization operation or selection of a particular improved spectrum utilization operation mode.

Transmitter 410 is configured to transmit data to one or more other devices, and receiver 412 is configured to receive data from one or more other devices. For example, transmitter 410 may transmit data, and receiver 412 may receive data, via a network, such as a wired network, a wireless network, or a combination thereof. For example, UE 115 may be configured to transmit and/or receive data via a direct device-to-device connection, a local area network (LAN), a wide area network (WAN), a modem-to-modem connection, the Internet, intranet, extranet, cable transmission system, cellular communication network, any combination of the above, or any other communications network now known or later developed within which permits two or more electronic devices to communicate. In some implementations, transmitter 410 and receiver 412 may be replaced with a transceiver. Additionally, or alternatively, transmitter 410, receiver, 412, or both may include or correspond to one or more components of UE 115 described with reference to FIG. 2.

Encoder 413 and decoder 414 may be configured to encode and decode data for transmission. Resource manager 415 may be configured to perform resource determination operations. For example, resource manager 415 may be configured to determine and/or indicate resources for particular transmissions in accordance with a maximum quantity of resources that is band specific/dependent on a frequency band. To illustrate, the resource manager 415 may determine a subset of resource elements from a larger pool of resource elements, where the larger pool of resource elements has with a maximum quantity of resources that is dependent on channel bandwidth, SCS, and frequency band. The frequency band may be indicated by a frequency band identifier, such as 1 or n1, or by spectrum and band, such as UHF 1. The resource manager 415 may determine a starting resource element and quantity of resource elements for a particular transmission from received scheduling information, such as from a RIV or SLIV indication.

Spectrum manager 416 may be configured to perform improved spectrum utilization operations, such spectrum and band determination operations and extension of 5G operations to broadcast spectrums. For example, spectrum manager 416 is configured to determine what spectrum and band to operation in. Additionally, spectrum manager 416 may be configured to determine a maximum quantity of resource elements for a particular spectrum or band thereof. For example, spectrum manager 416 may be configured to determine a maximum quantity of resource elements for additional SCS values and/or for particular frequency bands.

Second UE 403 may include one or more elements similar to UE 115. In some implementations, the UE 115 and the second UE 403 are different types of UEs. For example, either UE may be a higher quality or have different operating constraints. To illustrate, one of the UEs may have a larger form factor or be a current generation device, and thus have more advanced capabilities and/or reduced battery constraints, higher processing constraints, etc.

Base station 105 includes processor 430, memory 432, transmitter 434, receiver 436, encoder 437, decoder 438, resource manager 439, spectrum manager 440, and antennas 234a-t. Processor 430 may be configured to execute instructions stores at memory 432 to perform the operations described herein. In some implementations, processor 430 includes or corresponds to controller/processor 240, and memory 432 includes or corresponds to memory 242. Memory 432 may be configured to store resource information data 406, carrier information data 408, spectrum information data 442, settings data 444, or a combination thereof, similar to the UE 115 and as further described herein.

Transmitter 434 is configured to transmit data to one or more other devices, and receiver 436 is configured to receive data from one or more other devices. For example, transmitter 434 may transmit data, and receiver 436 may receive data, via a network, such as a wired network, a wireless network, or a combination thereof. For example, UEs and/or base station 105 may be configured to transmit and/or receive data via a direct device-to-device connection, a local area network (LAN), a wide area network (WAN), a modem-to-modem connection, the Internet, intranet, extranet, cable transmission system, cellular communication network, any combination of the above, or any other communications network now known or later developed within which permits two or more electronic devices to communicate. In some implementations, transmitter 434 and receiver 436 may be replaced with a transceiver. Additionally, or alternatively, transmitter 434, receiver, 436, or both may include or correspond to one or more components of UE 115 described with reference to FIG. 2.

Encoder 437, and decoder 438 may include the same functionality as described with reference to encoder 413 and decoder 414, respectively. Resource manager 439 may include similar functionality as described with reference to resource manager 415. For example, the resource manager 439 may be configured to determine and indicate resources for particular transmissions in accordance with a maximum quantity of resources that is band specific/dependent on a frequency band. Spectrum manager 440 may include similar functionality as described with reference to spectrum manager 416.

During operation of wireless communications system 400, the network (e.g., base station 105) may determine that UE 115 has improved spectrum utilization capability. For example, UE 115 may transmit a message 448 that includes an improved spectrum utilization indicator 490 (e.g., an improved spectrum utilization capability indicator).

Indicator 490 may indicate improved spectrum utilization capability for one or more communication modes, such as downlink, uplink, etc. In some implementations, a network entity (e.g., a base station 105) sends control information to indicate to UE 115 that improved spectrum utilization operation and/or a particular type of improved spectrum utilization operation is to be used. For example, in some implementations, configuration transmission 450 is transmitted to the UE 115. The configuration transmission 450 may include or indicate to use improved spectrum utilization operations or to adjust or implement a setting of a particular type of improved spectrum utilization operation. For example, the configuration transmission 450 may include resource information data 406, as indicated in the example of FIG. 4, carrier information data 408, spectrum information data 442, settings data 444 or any combination thereof.

During operation, devices of wireless communications system 400, perform improved spectrum utilization operations. For example, the network and UE 115 may exchange transmissions via uplink and/or downlink communications with enhanced or band specific maximum quantities for resource elements as illustrated in the example of FIG. 4.

In the example of FIG. 4, the base station 105 transmits a least a portion of scheduling information to the UE 115 via a downlink channel. As illustrated, the scheduling information (at least a portion thereof) is transmitted in a configuration message 452 from the base station 105 to the UE 115. The configuration message 452 corresponds to a RRC in the example of FIG. 4. In other implementations, the configuration message 452 may include or correspond to broadcast message, a PDCCH, SCI, a SL-MAC-CE, or a SL-RRC message.

The base station 105 optionally in some implementations transmits the scheduling information (at least a portion thereof) in as second message or transmission, such as signaling message 454. The signaling message 454 may include or correspond to a PDCCH transmission, such as DCI, a PDSCH transmission, a MAC-CE transmission, a SL transmission, a broadcast transmission, etc. For example, the base station 105 may transmit a first portion of the scheduling information in the configuration message 452 and a second portion of the scheduling information in the signaling message 454. To illustrate, the base station 105 may transmit the configuration information (e.g., of the scheduling information in the configuration message 452 (e.g., RRC) and the timing information (e.g., Type 0 or 1 resource allocation information) of the scheduling information in the signaling message 454 (e.g., DCI). In some implementations, the scheduling information (e.g., the configuration message 452, the signaling message 454, or both) or a portion of the scheduling information (e.g., the configuration message 452 or the signaling message 454) is broadcast or groupcast to multiple UEs, such as the UE 115 and the second UE 403.

As illustrative, non-limiting examples, the band (location and channel bandwidth), SCS and numerology (cyclic prefix) may be indicated in the locationAndBandwidth, subcarrierSpacing and cyclicPrefix fields of a BWP information element, such as in the IE BWP. Bandwidth parts and information thereof may be further configured by the IE ServingCellConfig. A number of consecutive RBs may be indicated using the higher layer parameter rbg-Size configured by PDSCH-Config for resource allocation Type 0, or using a resource indication value (RIV) that provides both a start RB number and length in terms of consecutive resource blocks for resource allocation Type 1.

The UE 115 transmits or receives a transmission or transmissions 456 based on the scheduling information, such as the configuration information, the timing information, or both. For example, the UE 115 transmits or receives a transmission or transmissions 456 based on one or more of the configuration message 452 and the signaling message 454. To illustrate, the UE 115 may transmit or receive a transmission using resource elements identified by timing information of the signaling message 454 in accordance with a maximum quantity of resource elements, where the maximum quantity of resource elements is based on parameters indicated in configuration information included in the configuration message 452.

Timing information may include or correspond to resource information in a particular domain. For example, the timing information may include or correspond to a frequency domain resource assignment (frequency domain resource assignment information) or a timing domain resource assignment (timing domain resource assignment information). The timing information may include time and/or frequency information for transmission resources.

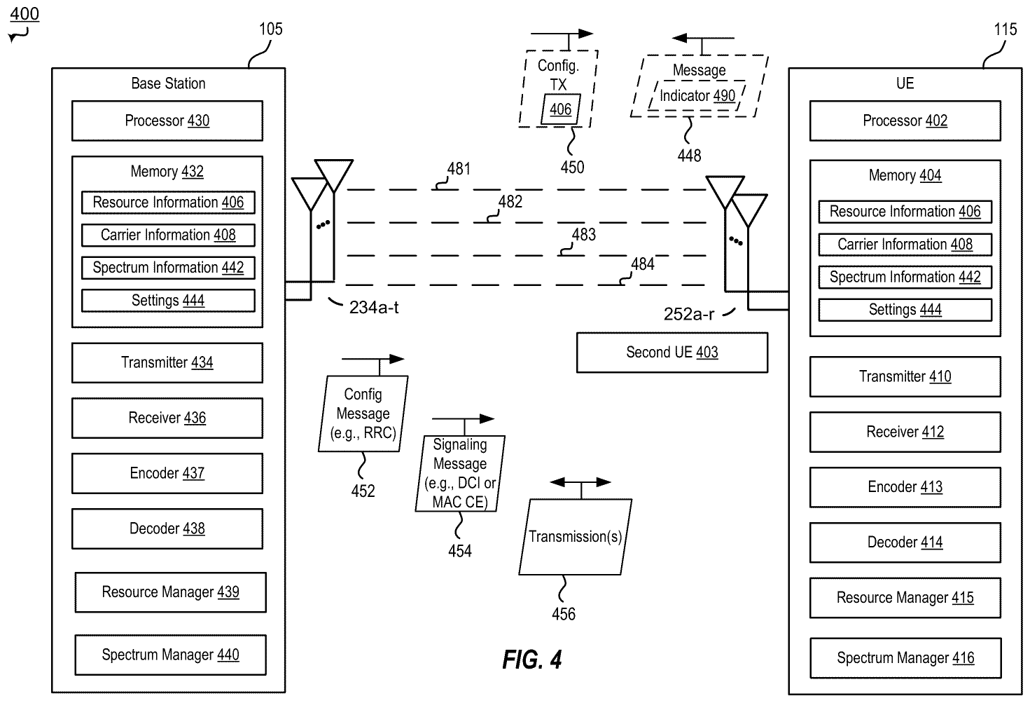

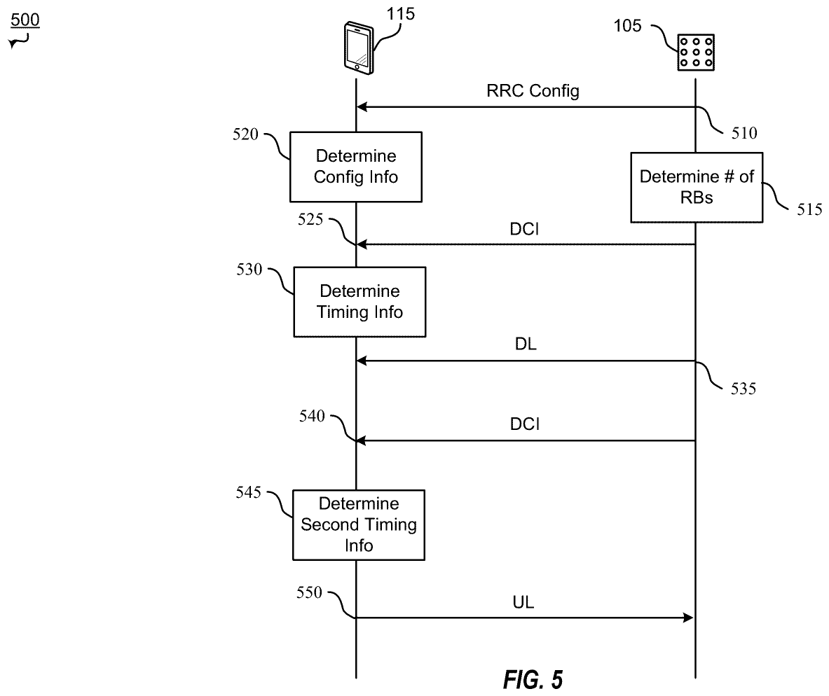

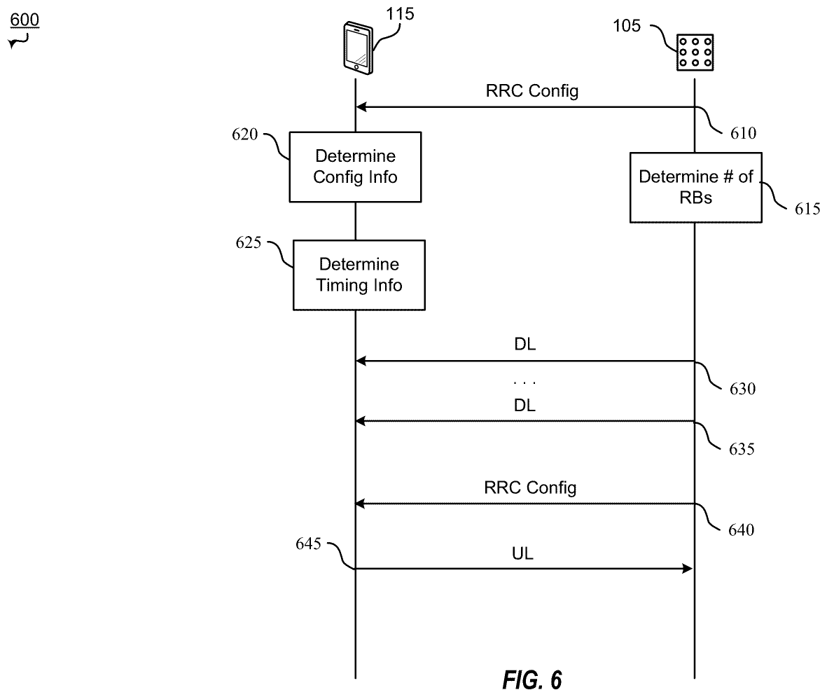

In some implementations, the UE 115 may transmit or receive additional transmissions (e.g., periodic) of the transmissions 456 based on the scheduling information, as described further with reference to FIGS. 6 and 7. In other implementations, the UE 115 may transmit or receive second transmissions (e.g., aperiodic) of the transmissions 456 based on second scheduling information received in additional transmissions, such as a second signaling transmission, as described further with reference to FIGS. 5 and 7.

Accordingly, the network (e.g., the base station 105, the UE 115, and the second UE 403) may be able to more efficiently and effectively make use of available spectrum by using larger quantities of resource elements, using smaller SCS values, and/or extending cellular operations to terrestrial broadcast bands (e.g., UHF, VHF, etc.). Improved spectrum utilization may reduce beam failure and radio link failure and reduce or prevent the use of recovery operations due to beam or link failure. Additionally, improved spectrum utilization may enable reduced capability devices, such as reduced with respect to physical capability and/or due to channel conditions, to operate in a predicted beam blockage mode. Accordingly, the network will experience reduced errors and latency, and increased throughput.

Referring to FIG. 5, FIG. 5 is a timing diagram 500 illustrating a wireless communication system that supports improved spectrum utilization according to one or more aspects. The example of FIG. 5 corresponds to an example of improved spectrum utilization for aperiodic operations.

The example of FIG. 5 includes similar devices to the devices described in FIGS. 1, 2, and 4, such as a UE 115 and a network entity (e.g., base station 105). The devices of FIG. 5 may include one or more of the components as described in FIGS. 2 and 4. In FIG. 5, these devices may utilize antennas 252a-r, transmitter 410, receiver 412, encoder 413 and/or decoder 414, or may utilize antennas 234a-t, transmitter 434, receiver 436, encoder 437 and/or decoder 438 to communicate and receive transmissions in accordance with per band maximum quantities of resource elements. In some implementations, network entity may include or correspond to multiple TRPs of a single base station (e.g., base station 105), to multiple base stations, or any combination thereof.

At 510, the base station 105 transmits configuration information to the UE 115. For example, the base station 105 may transmit a downlink transmission including configuration information. As illustrated in the example of FIG. 5, the base station 105 transmits RRC signaling (e.g., a RRC transmission or message), including the configuration information, to the UE 115.

As described with reference to FIG. 4, the configuration information may include or indicate a first maximum quantity of resources. For example, the configuration information may indicate a first channel bandwidth, first frequency band information, and a first SCS which defines or dictates the first maximum quantity of resources. The downlink transmission may include or correspond to a RRC message, a MAC-CE, DCI, a PDCCH, or a PDSCH.

At 515, the base station 105 may determine a maximum quantity of resource elements to use for an upcoming transmission or transmissions. For example, the base station 105 may determine a first maximum quantity of resources for a particular transmission (e.g. a first transmission) based on the first channel bandwidth, the first frequency band information, and the first SCS. Determining the maximum quantity of resource elements may include calculating the maximum quantity of resource elements or retrieving the maximum quantity of resource elements from memory (e.g., a table or data structure). Alternatively, as described with reference to FIG. 7, the first maximum quantity of resources may be for multiple transmissions (e.g., a set of periodic transmissions) which have the same channel bandwidth, frequency band, and SCS.

Although the example of FIG. 5 illustrates that the base station 105 determines the first maximum quantity of resources after transmitting the configuration information at 510, the base station 105 may determine the first maximum quantity of resources before or after transmitting the configuration information at 510. For example, the base station 105 may determine the first maximum quantity of resources before transmitting the configuration information at 510. To illustrate, the base station 105 may determine the first maximum quantity of resources upon startup, configuration, periodically, etc. As another example, the base station 105 may determine the first maximum quantity of resources after transmitting the configuration information at 510. To illustrate, the base station 105 may determine the first maximum quantity of resources after configuration of a channel or a UE.

Additionally, or alternatively, the UE 115 may determine the first maximum quantity of resources. The UE 115 may determine the first maximum quantity of resources after the base station 105 and after receiving the configuration information at 510. Alternatively, the UE 115 may determine the first maximum quantity of resources upon startup, configuration, periodically, etc.

At 520, the UE 115 determines the configuration information. For example, the UE 115 may receive and parse the transmission at 510 from the base station 105 to determine the configuration information. The configuration information may include or correspond to the configuration information described with reference to FIG. 4, such as carrier information data 408. To illustrate, the configuration information may include or indicate the first channel bandwidth, the first frequency band information, the first SCS, or a combination thereof.

At 525, the base station 105 transmits a signaling indication including timing information, such as time and/or frequency information for transmission resources. For example, the base station 105 may transmit a portion of the scheduling information in a downlink transmission. As illustrated in the example of FIG. 5, the base station transmits DCI including timing information. The timing information may include or correspond to the timing information described with reference to FIG. 4. For example, the timing information may include or indicate a starting resource and a quantity of resources for the particular transmission. To illustrate, the timing information may include or indicate a RIV for a particular BWP, which indicates the starting resource and the quantity of resources for the particular transmission. As another illustration, the timing information may indicate resources using common reference element and an offset or through a bitmap. In other implementations, the base station 105 may transmit a PDCCH, a MAC CE, a RRC, or another type of transmission.

At 530, the UE 115 may determine timing information based on receiving the signaling indication. For example, the UE 115 may receive and parse a signaling indication (signaling transmission) to determine or identify signaling information. The signaling information may include or indicate the scheduling information or a portion thereof, such as the timing information. As illustrated in the example of FIG. 5, the UE 115 receives a DCI including an indication of a RIV, and from the RIV the UE 115 determines the starting resource and the quantity of resources for the particular transmission.

At 535, the base station 105 transmits the particular transmission to the UE 115 in accordance with the first maximum quantity of resources. For example, the base station 105 transmits a PDSCH to the UE 115 where the resources used for transmission are from a pool of resources of the channel bandwidth which is determined based additionally on the frequency band, as opposed to only channel bandwidth and SCS. By utilizing the frequency band, the first maximum quantity of resources can be larger due to utilization/optimization of resource allocation. A larger maximum quantity of resources leads to larger individual allocations/transmission bandwidths, and increased throughput.

Additionally, or alternatively, the UE 115 transmits the particular transmission to the base station 105. For example, the UE 115 transmits a PUSCH to the base station 105. The particular transmission transmitted by the UE 115 or the base station 105 may include or correspond to a transmission of the transmission(s) 456 of FIG. 4.

At 540, the base station 105 transmits a second signaling indication including second timing information. For example, the base station 105 may transmit a second portion of the scheduling information or second scheduling information. As illustrated in the example of FIG. 5, the base station transmits second DCI including second timing information. The second timing information may include or correspond to the timing information described with reference to FIG. 4. For example, the second timing information may include or indicate a second starting resource and a second quantity of resources for the second particular transmission. To illustrate, the second timing information may include or indicate a second RIV for a second particular BWP, which indicates the second starting resource and the second quantity of resources for the second particular transmission. In other implementations, the base station 105 may transmit a PDCCH, a MAC CE, a RRC, or another type of transmission.

At 545, the UE 115 may determine second timing information based on receiving the second signaling indication. For example, the UE 115 may receive and parse a second signaling indication (second signaling transmission) to determine or identify second signaling information. The second signaling information may include or indicate the scheduling information or a portion thereof, such as the second timing information. As illustrated in the example of FIG. 5, the UE 115 receives a second DCI including an indication of a second RIV, and from the second RIV the UE 115 determines the second starting resource and the second quantity of resources for the second particular transmission.

At 550, the base station 105 transmits the second particular transmission to the UE 115 in accordance with the second maximum quantity of resources. For example, the base station 105 transmits a second PDSCH to the UE 115 where the resources used for transmission are from a pool of resources of the channel bandwidth which is determined based additionally on the frequency band, as opposed to only channel bandwidth and SCS.

By utilizing the frequency band, the first maximum quantity of resources can be larger due to enhanced optimization of resource allocation. A larger maximum quantity of resources leads to larger individual allocations/transmission bandwidths, and increased throughput.

Additionally, or alternatively, the UE 115 transmits the second particular transmission to the base station 105. For example, the UE 115 transmits a second PUSCH to the base station 105. The second particular transmission transmitted by the UE 115 or the base station 105 may include or correspond to a second transmission of the transmission(s) 456 of FIG. 4.

Accordingly, in the example, of FIG. 5, device of the network may select from a larger pool of resources for a particular channel bandwidth that is also based on the particular frequency band.

Referring to FIG. 6, FIG. 6 is a timing diagram 600 illustrating a wireless communication system that supports improved spectrum utilization according to one or more aspects. The example of FIG. 6 may include or correspond to an example of improved spectrum utilization for periodic operations.

The example of FIG. 6 includes similar devices to the devices described in FIGS. 1, 2, and 4, such as a UE 115 and a network entity (e.g., base station 105). The devices of FIG. 6 may include one or more of the components as described in FIGS. 2 and 4. In FIG. 6, these devices may utilize antennas 252a-r, transmitter 410, receiver 412, encoder 413 and/or decoder 414, or may utilize antennas 234a-t, transmitter 434, receiver 436, encoder 437 and/or decoder 438 to communicate and receive transmissions in accordance with per band maximum quantities of resource elements. In some implementations, network entity may include or correspond to multiple TRPs of a single base station (e.g., base station 105), to multiple base stations, or any combination thereof.

At 610, the base station 105 transmits scheduling information to the UE 115. For example, the base station 105 may transmit a downlink transmission including or indicating configuration information and timing information. As illustrated in the example of FIG. 5, the base station 105 transmits RRC signaling (e.g., a RRC transmission or message), indicating the scheduling information, to the UE 115. The scheduling information or a portion thereof may be indicated by one or more RRC configurations, such as RRC information elements.

As described with reference to FIG. 4, the configuration information may include or indicate a first maximum quantity of resources based on a first channel bandwidth, first frequency band information, and a first SCS. The downlink transmission may include or correspond to a RRC message, a MAC-CE, DCI, a PDCCH, or a PDSCH.

In the example of FIG. 6, the configuration information may include or correspond to periodic configuration information, such as static or semi-static information. The configuration information may include or indicate information for multiple transmissions, such as multiple uplink transmissions, downlink transmissions, or both. The configuration information may indicate the first maximum quantity of resources directly or indirectly, such as by indicating the first channel bandwidth, the first frequency band information, and the first SCS.

The timing information may include or correspond to the timing information described with reference to FIG. 4. For example, the timing information may include or indicate a starting resource and a quantity of resources for the particular transmission. To illustrate, the timing information may include or indicate a RIV for a particular BWP, which indicates the starting resource and the quantity of resources for the particular transmission. In other implementations, the base station 105 may transmit a PDCCH, a MAC CE, a RRC, or another type of transmission.

At 615, the base station 105 may determine a maximum quantity of resource elements to use for an upcoming transmission or transmissions. For example, the base station 105 may determine the first maximum quantity of resources for multiple transmissions based on the first channel bandwidth, the first frequency band information, and the first SCS. Alternatively, as described with reference to FIG. 5, the first maximum quantity of resources may be for a single transmission (e.g., an aperiodic transmission).

Although the example of FIG. 6 illustrates that the base station 105 determines the first maximum quantity of resources after transmitting the configuration information at 610, the base station 105 may determine the first maximum quantity of resources before or after transmitting the configuration information at 610. For example, the base station 105 may determine the first maximum quantity of resources before transmitting the configuration information at 610. To illustrate, the base station 105 may determine the first maximum quantity of resources upon startup, configuration, periodically, etc. As another example, the base station 105 may determine the first maximum quantity of resources after transmitting the configuration information at 610. To illustrate, the base station 105 may determine the first maximum quantity of resources after configuration of a channel or a UE.

Additionally, or alternatively, the UE 115 may determine the first maximum quantity of resources. The UE 115 may determine the first maximum quantity of resources after the base station 105 and after receiving the configuration information at 610. Alternatively, the UE 115 may determine the first maximum quantity of resources upon startup, configuration, periodically, etc.

At 620, the UE 115 determines the configuration information. For example, the UE 115 may receive and parse the transmission at 610 from the base station 105 to determine the configuration information. The configuration information may include or correspond to the configuration information described with reference to FIG. 4, such as carrier information data 408. To illustrate, the configuration information may include or indicate the first channel bandwidth, the first frequency band information, the first SCS, or a combination thereof.

At 625, the UE 115 may determine timing information based on receiving the scheduling information. For example, the UE 115 may receive and parse a signaling indication (scheduling/configuration transmission) to determine or identify timing information from scheduling information. The timing information may include or correspond to an indication of a RIV, and from the RIV the UE 115 determines the starting resource and the quantity of resources for the particular transmission.

At 630, the base station 105 transmits a first transmission to the UE 115 in accordance with the first maximum quantity of resources. For example, the base station 105 transmits a PDSCH to the UE 115 where the resources used for transmission are from a pool of resources of the channel bandwidth which is determined based additionally on the frequency band, as opposed to only channel bandwidth and SCS. By utilizing the frequency band, the first maximum quantity of resources can be larger due to utilization/optimization of resource allocation. A larger maximum quantity of resources leads to larger individual allocations/transmission bandwidths, and increased throughput.

Additionally, or alternatively, the UE 115 transmits the particular transmission to the base station 105. For example, the UE 115 transmits a PUSCH to the base station 105. The particular transmission transmitted by the UE 115 or the base station 105 may include or correspond to a transmission of the transmission(s) 456 of FIG. 4.

At 635, the base station 105 transmits a second transmission to the UE 115 in accordance with the first maximum quantity of resources (or a first maximum quantity of resources). For example, the base station 105 transmits a PDSCH to the UE 115 where the resources used for transmission are from a pool of resources of the channel bandwidth which is determined based additionally on the frequency band, as opposed to only channel bandwidth and SCS. By utilizing the frequency band, the first maximum quantity of resources can be larger due to utilization/optimization of resource allocation. A larger maximum quantity of resources leads to larger individual allocations/transmission bandwidths, and increased throughput.

From 630 to 635 the base station 105 and/or the UE 115 may transmit one or more additional transmissions. For example the base station 105 may transmit a third transmission in accordance with the first maximum quantity of resources, the second maximum quantity of resources, or a third maximum quantity of resources.

Additionally, or alternatively, the UE 115 transmits the particular transmission to the base station 105. For example, the UE 115 transmits a PUSCH to the base station 105. The particular transmission or transmissions transmitted by the UE 115 or the base station 105 may include or correspond to a transmission of the transmission(s) 456 of FIG. 4.

At 540, the base station 105 transmits second scheduling information to the UE 115. For example, the base station 105 may transmit an adjustment to the scheduling information or second scheduling information. As illustrated in the example of FIG. 5, the base station transmits second DCI including second scheduling information. The second scheduling information may include or correspond to the timing information described with reference to FIG. 4. For example, the second scheduling information may include or indicate a periodic timing information for multiple uplink transmissions by the UE 115. In other implementations, the base station 105 may transmit a PDCCH, a MAC CE, a RRC, or another type of transmission.

At 545, the UE 115 may determine second timing information based on receiving the second scheduling information. For example, the UE 115 may receive and parse a second signaling indication (second signaling transmission) to determine or identify the second scheduling information. As illustrated in the example of FIG. 5, the UE 115 receives a second DCI including an indication of a second RIV, and from the second RIV the UE 115 determines the second starting resource and the second quantity of resources for the second particular transmission.

Referring to FIG. 7, FIG. 7 is a timing diagram 700 illustrating a wireless communication system that supports improved spectrum utilization according to one or more aspects. The example of FIG. 7 may include or correspond to an example of improved spectrum utilization for broadcast operations.

The example of FIG. 7 includes similar devices to the devices described in FIGS. 1, 2, and 4, such as a first UE 115A, a second UE 115B, and a network entity (e.g., base station 105). The devices of FIG. 7 may include one or more of the components as described in FIGS. 2 and 4. In FIG. 7, these devices may utilize antennas 252a-r, transmitter 410, receiver 412, encoder 413 and/or decoder 414, or may utilize antennas 234a-t, transmitter 434, receiver 436, encoder 437 and/or decoder 438 to communicate and receive transmissions in accordance with per band maximum quantities of resource elements. In some implementations, network entity may include or correspond to multiple TRPs of a single base station (e.g., base station 105), to multiple base stations, or any combination thereof.

At 710, the base station 105 transmits configuration information to the one or more UEs. For example, the base station 105 may transmit (e.g., broadcast) a broadcast downlink transmission including configuration information to multiple UEs. As illustrated in the example of FIG. 7, the base station 105 transmits RRC signaling (e.g., a RRC transmission or message), including the configuration information, to the first UE 115A and the second UE 115B.

As described with reference to FIG. 4, the configuration information may include or indicate a first maximum quantity of resources based on a first channel bandwidth, first frequency band information, and a first SCS. The downlink transmission may include or correspond to a RRC message, a MAC-CE, DCI, a PDCCH, a PDSCH, a multicast control channel (MCCH), a system information block (SIB), or multicast session information (MSI).

At 715, the base station 105 may determine a maximum quantity of resource elements to use for an upcoming transmission or transmissions. For example, the base station 105 may determine a first maximum quantity of resources for a particular transmission (e.g. a first transmission) based on the first channel bandwidth, the first frequency band information, and the first SCS. Alternatively the first maximum quantity of resources may be for multiple transmissions (e.g., a set of periodic transmissions or broadcast transmission) which have the same channel bandwidth, frequency band, and SCS.

Although the example of FIG. 7 illustrates that the base station 105 determines the first maximum quantity of resources after transmitting the configuration information at 710, the base station 105 may determine the first maximum quantity of resources before or after transmitting the configuration information at 710. For example, the base station 105 may determine the first maximum quantity of resources before transmitting the configuration information at 710. To illustrate, the base station 105 may determine the first maximum quantity of resources upon startup, configuration, periodically, etc. As another example, the base station 105 may determine the first maximum quantity of resources after transmitting the configuration information at 710. To illustrate, the base station 105 may determine the first maximum quantity of resources after configuration of a channel or a UE.

Additionally, or alternatively, the first UE 115A and/or the second UE 115B may determine the first maximum quantity of resources. The first UE 115A and/or the second UE 115B may determine the first maximum quantity of resources after the base station 105 and after receiving the configuration information at 710. Alternatively, the UE 115 may determine the first maximum quantity of resources upon startup, configuration, periodically, etc.

At 720, the UE 115 determines the configuration information. For example, the first UE 115A and the second UE 115B may receive and parse the transmission at 710 from the base station 105 to determine the configuration information. The configuration information may include or correspond to the configuration information described with reference to FIG. 4, such as carrier information data 408. To illustrate, the configuration information may include or indicate the first channel bandwidth, the first frequency band information, the first SCS, or a combination thereof.

At 725, the base station 105 transmits a signaling indication including timing information. For example, the base station 105 may transmit a portion of the scheduling information. As illustrated in the example of FIG. 5, the base station transmits DCI including timing information to the first UE 115A and the second UE 115B. The timing information may include or correspond to the timing information described with reference to FIG. 4. For example, the timing information may include or indicate a starting resource and a quantity of resources for the particular transmission. To illustrate, the timing information may include or indicate a RIV for a particular BWP, which indicates the starting resource and the quantity of resources for the particular transmission. In other implementations, the base station 105 may transmit a PDCCH, a MAC CE, a RRC, or another type of transmission.

At 730, the first UE 115A and the second UE 115B may determine timing information based on receiving the signaling indication. For example, the first UE 115A and the second UE 115B may receive and parse a signaling indication (signaling transmission) to determine or identify signaling information. The signaling information may include or indicate the scheduling information or a portion thereof, such as the timing information. As illustrated in the example of FIG. 5, the first UE 115A and the second UE 115B receive a DCI including an indication of a RIV, and from the RIV the UE 115 determines the starting resource and the quantity of resources for the particular transmission.

At 735, the base station 105 transmits the particular transmission to the first UE 115A and the second UE 115B in accordance with the first maximum quantity of resources. For example, the base station 105 transmits a PDSCH to the first UE 115A and the second UE 115B where the resources used for transmission are from a pool of resources of the channel bandwidth which is determined based additionally on the frequency band, as opposed to only channel bandwidth and SCS. By utilizing the frequency band, the first maximum quantity of resources can be larger due to utilization/optimization of resource allocation. A larger maximum quantity of resources leads to larger individual allocations/transmission bandwidths, and increased throughput.

Additionally, or alternatively, the first UE 115A and/or the second UE 115B transmits the particular transmission to the base station 105. For example, the first UE 115A transmits a PUSCH to the base station 105. The particular transmission transmitted by the first UE 115A, the second UE 115B, or the base station 105 may include or correspond to a transmission of the transmission(s) 456 of FIG. 4.

Optionally, the nodes of FIG. 7 may perform additionally downlink operations based on the above signaling transmissions and scheduling information or based on additional transmissions and scheduling information. In a particular implementation, the nodes may optionally perform uplink operations as described below. Such optional steps and transmissions have been shown in dotted lines.

At 740, the base station 105 transmits a second signaling indication including second scheduling information. For example, the base station 105 may transmit a second portion of the scheduling information or second scheduling information. As illustrated in the example of FIG. 5, the base station transmits second DCI including second timing information. The second timing information may include or correspond to the timing information described with reference to FIG. 4. For example, the second timing information may include or indicate a second starting resource and a second quantity of resources for the second particular transmission. To illustrate, the second timing information may include or indicate a second RIV for a second particular BWP, which indicates the second starting resource and the second quantity of resources for the second particular transmission. In other implementations, the base station 105 may transmit a PDCCH, a MAC CE, a RRC, or another type of transmission.

At 745, the first UE 115A and the second UE 115B may determine second timing information based on receiving the second signaling indication. For example, the first UE 115A and the second UE 115B may receive and parse a second signaling indication (second signaling transmission) to determine or identify second scheduling information. The second scheduling information may include or indicate the scheduling information or a portion thereof, such as the second timing information.

At 750, one or more of the UEs transmit the second particular transmission to the base station 105. For example, the first UE 115A transmits a second PUSCH to the base station 105. The second particular transmission transmitted by the first UE 115A, the second UE 115B, or the base station 105 may include or correspond to a second transmission of the transmission(s) 456 of FIG. 4

Additionally, or alternatively, the base station 105 may transmit the second particular transmission to one or more UEs in accordance with the second maximum quantity of resources at 750. For example, the base station 105 transmits (broadcasts) a second PDSCH to the first UE 115A and the second UE 115B where the resources used for transmission are from a pool of resources of the channel bandwidth which is determined based additionally on the frequency band, as opposed to only channel bandwidth and SCS. By utilizing the frequency band, the first maximum quantity of resources can be larger due to utilization/optimization of resource allocation. A larger maximum quantity of resources leads to larger individual allocations/transmission bandwidths, and increased throughput.

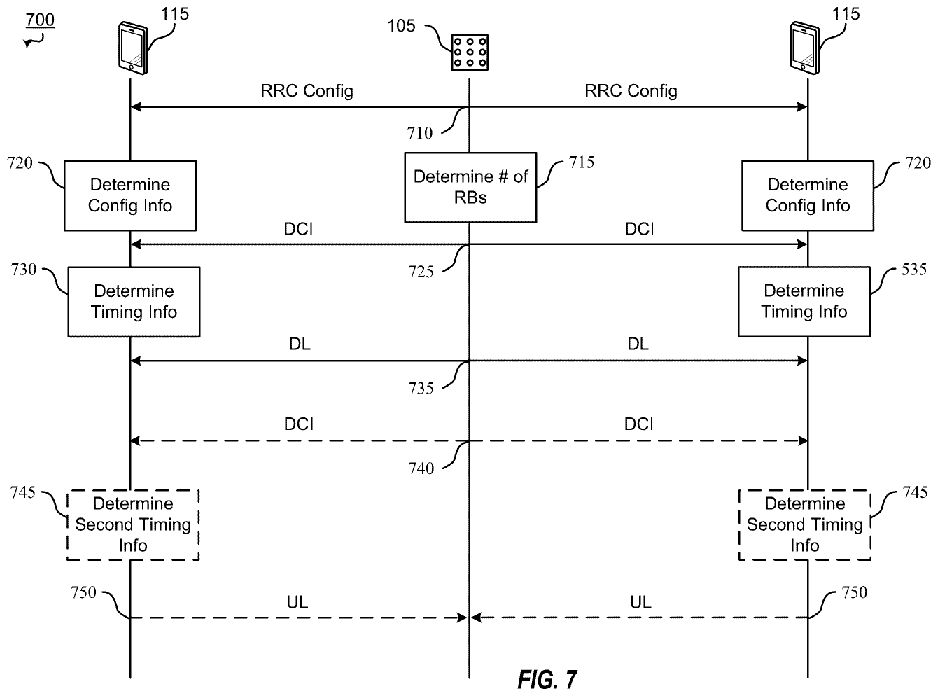

FIGS. 8A-8C illustrate examples of maximum transmission bandwidth configurations per band. FIG. 8A depicts a table of values for a maximum quantity of resource elements for different combinations of channel bandwidth, SCS, and band for multiple frequency spectrums. FIGS. 8B and 8C each depict a table of values for a maximum quantity of resource elements for different combinations of channel bandwidth, SCS, and band for a particular frequency spectrum. Although no illustrative values are provided for the maximum quantities of resource elements in the examples of FIGS. 8A-8C, each blank cell in the tables represents an individual entry. In some aspects, each entry may be different from any other entry. In other aspects, one or more entries may be different from one or more other entries, and one or more entries may be the same as one or more other entries. The additional entries, as compared entries of the table 320 of FIG. 3C, enable additional band-specific configurations for maximum quantities of resource elements.

FIG. 8A illustrates a table 800 of maximum transmission bandwidth configurations per band. The table 800 includes a maximum transmission bandwidth configuration for each combination of UE channel bandwidth, subcarrier spacing, and band. As compared to the maximum transmission bandwidth configurations in FIG. 3C, the table 800 in FIG. 8A includes a maximum transmission bandwidth configuration value for each band for a particular combination of channel bandwidth and subcarrier spacing. In the example table of FIG. 8A, the table 800 includes bands from multiple spectrums, such as a first spectrum (spectrum A) and a second spectrum (spectrum B).

FIG. 8B illustrates another table of maximum transmission bandwidth configurations per band. In FIG. 8B, a table 810 illustrates maximum transmission bandwidth configuration for each combination of UE channel bandwidth, subcarrier spacing, and band for a first spectrum. FIG. 8C illustrates another table of maximum transmission bandwidth configurations per band. In FIG. 8C, a table 820 illustrates maximum transmission bandwidth configuration for each combination of UE channel bandwidth, subcarrier spacing, and band for a second spectrum. As compared to the maximum transmission bandwidth configurations in FIG. 3C, the tables in FIGS. 8B and 8C include a maximum transmission bandwidth configuration value for each band for a particular combination of channel bandwidth and subcarrier spacing.

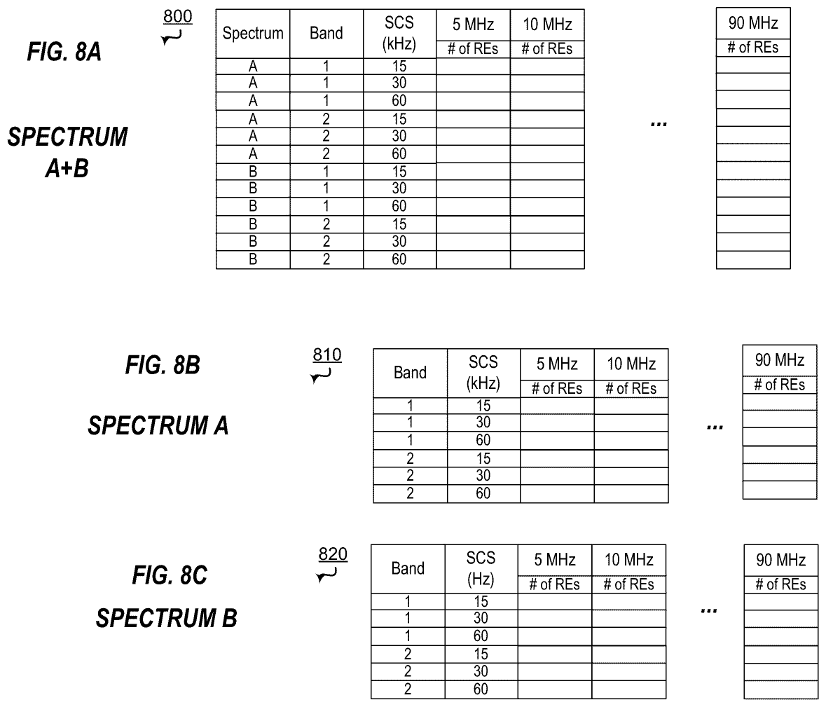

FIGS. 9A and 9B illustrate other examples of maximum transmission bandwidth configurations per band. FIG. 9A depicts a table where the rows and maximum transmission bandwidth configuration values for a maximum quantity of resource blocks are grouped by SCS. FIG. 9B depicts a table where the rows and maximum transmission bandwidth configuration values for a maximum quantity of resource blocks are grouped by band. Although no illustrative values are provided for the maximum quantities of resource elements in the examples of FIGS. 9A and 9B, each blank cell in the tables represents an individual entry. In some aspects, each entry may be different from any other entry. In other aspects, one or more entries may be different from one or more other entries, and one or more entries may be the same as one or more other entries. The additional entries, as compared entries of the table 320 of FIG. 3C, enable additional band-specific configurations for maximum quantities of resource elements

Referring to FIG. 9A, a portion of a table 900 depicting maximum transmission bandwidth configurations per band and arranged by SCS grouping. As illustrated in FIG. 9A, maximum transmission bandwidth configuration values for a first SCS (15 kHz) are grouped together and there are unique maximum transmission bandwidth configurations for the first SCS (15 kHz) for a first band (n1) and a second band (n2).

Specifically, there are multiple first maximum transmission bandwidth configuration values for a combination of the first SCS (15 kHz) and a first band (n1) in a first row (row 1) and multiple second maximum transmission bandwidth configuration values for a combination of the first SCS (15 kHz) and a second band (n2) in a second row (row 2).

The first and second multiple maximum transmission bandwidth configuration values include a value for each channel bandwidth for each unique combination of SCS and band.

Referring to FIG. 9B, a portion of a table 910 depicting maximum transmission bandwidth configurations per band and arranged by band grouping. As illustrated in FIG. 9B, maximum transmission bandwidth configuration values for a first band (n1) are grouped together and there are unique maximum transmission bandwidth configurations for the first band (n1) for a first SCS (15 kHz), a second SCS (30 kHz), and a third SCS (60 kHz). Specifically, there are multiple first maximum transmission bandwidth configuration values for a combination of the first SCS (15 kHz) and a first band (n1) in a first row (row 1) and multiple second maximum transmission bandwidth configuration values for a combination of a second SCS (30 kHz) and the first band (n1) in a second row (row 2). The first and second multiple maximum transmission bandwidth configuration values include a value for each channel bandwidth for each unique combination of SCS and band.

The tables 900 and 910 depicted in FIGS. 9A and 9B are per frequency spectrum. For example, a device may include a table as in FIG. 9A or 9B per spectrum, such as a first table for FR1, a second table for FR2, a third table for UHF, etc. In other implementations, a device may include a table arranged as in FIG. 9A or FIG. 9B for multiple spectrums, such as described with reference to FIG. 8A. In implementations, where a device includes multiple tables, the data or information of the multiple tables may be included in or represented by one or more data structures. Additionally, although tables are illustrated in FIGS. 8A-9B, in other implementations other types of data structures may be used, vectors, lists, matrices, etc., to store the maximum transmission bandwidth configurations per band.

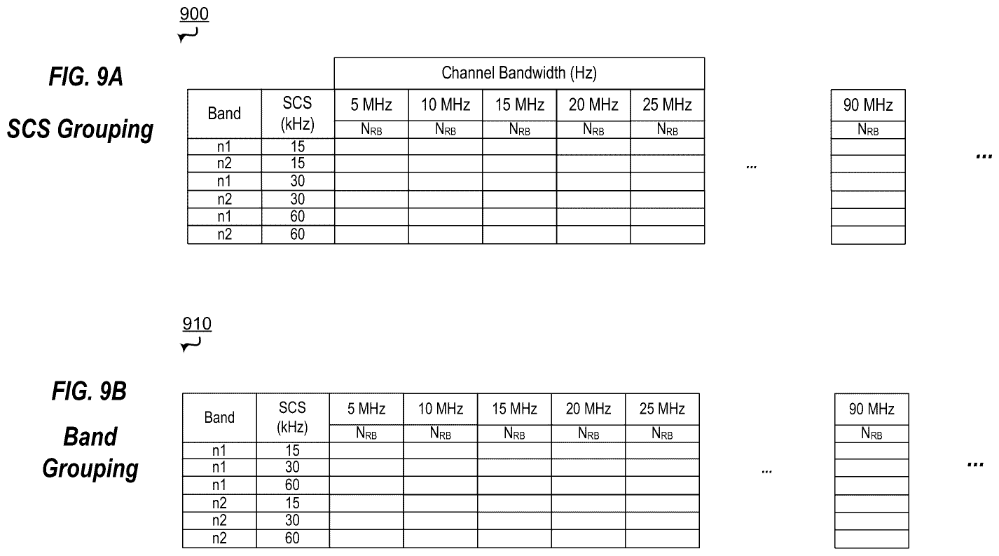

FIGS. 10A and 10B illustrates example tables with spectral occupancy information for various spectrums. FIG. 10A illustrates an example table for NR spectrum. FIG. 10B illustrates an example table for UHF spectrum.

In FIG. 10A, the table 1000 illustrates spectral occupancy for NR downlink for several SCS. Spectral occupancy is shown by a maximum quantity of resource blocks and by an increase in spectral utilization over the corresponding legacy NR.

In FIG. 10B, the table 1010 illustrate spectral occupancy for UHF HO for several SCS. Spectral occupancy is shown by a maximum quantity of resource blocks and by a percent utilization of the channel bandwidth. The percent utilization corresponds to the maximum quantity of resource blocks divided by a theoretical limit of resource blocks of the channel bandwidth without accounting for guardbands/spectral emissions.

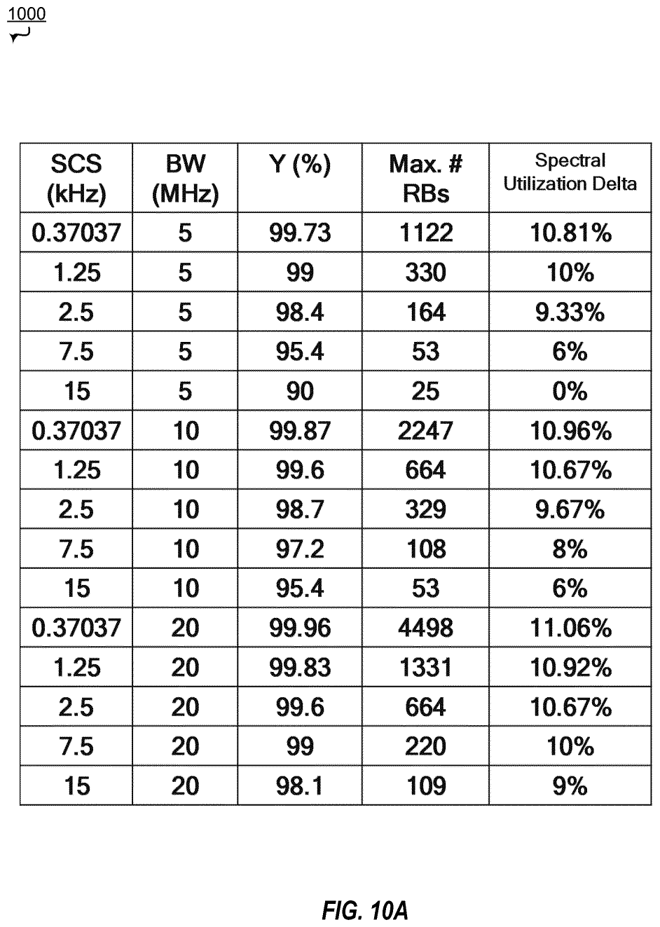

FIGS. 11A and 11B illustrates example graphs with spectral occupancy information for various spectrums. FIG. 11A illustrates an example graph for NR spectrum. FIG. 10B illustrates an example graph for UHF spectrum. In FIGS. 11A and 11B, dotted lines correspond to OOBE for particular combinations of channel bandwidth, SCS, and band and solid lines represent spectral masks.

FIG. 11A illustrate graphs of spectrum occupancy for 5G NR. In FIG. 11A, graph 1100 illustrates PSD (in dBm/kHz) versus frequency in MHz. In graph 1100, a SEM for 5G spectrum is shown in a bold black line and various spectral leakage curves are illustrated for different combinations of bandwidth and SCS and illustrating different spectral occupancies/efficiencies.

FIG. 11B illustrate graphs of spectrum occupancy for UHF. In FIG. 11B, graph 1110 illustrates PSD (in dBm/kHz) versus frequency in MHz. In graph 1100, a SEM for UHF frequency spectrum is shown in a bold black line and various spectral leakage curves are illustrated for different combinations of bandwidth and SCS and illustrating different spectral occupancies/efficiencies.

From the example tables and charts, the change in maximum resource elements is not always linear. Maximizing resource elements, or “optimizing” spectral occupancy depends on multiple factors. For example, increase resource elements depends on the interplay between SCS, SEM (which depends on a specific band—e.g., UHF v LTE/NR), and bandwidth.

In NR, such as for NR DL bands, up to a 10.8% increase in spectral efficiency can be obtained when the channel bandwidth is 5 MHz and the SCS is 0.37037 kHz over the current NR value (i.e., non-band specific value). Additionally, up to a 11.1% increase can be obtained when the channel bandwidth is 20 MHz and the SCS is 15 kHz and higher. In the UHF band, different optimum spectral occupancy values are obtained as a function of the SCS.

For longer numerologies (such as for smaller SCS values) and, hence, larger quantities of resource elements for a given spectrum occupancy, we would potentially need larger maximum transport block size (TBS) values as compared to current 5G broadcast configurations to take advantage of the larger quantities of available resource elements. In other bands, such as in UHF bands, due to the markedly less spectral occupancy, smaller maximum TBS values may be specified.

As compared to 5G, the SEM for UHF is much more stringent than that of LTE/NR. As a result, less spectral occupancy than that in a cellular band is achievable. The increase in occupancy with smaller SCS is less pronounced in UHF bands.

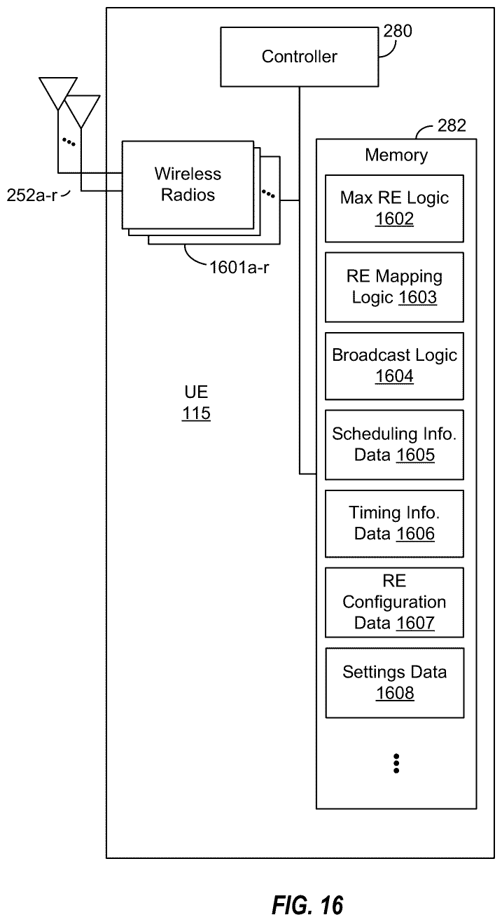

FIG. 12 is a flow diagram illustrating example blocks executed by a wireless communication device (e.g., a UE or base station) configured according to an aspect of the present disclosure. The example blocks will also be described with respect to UE 115 as illustrated in FIG. 16. FIG. 16 is a block diagram illustrating UE 115 configured according to one aspect of the present disclosure. UE 115 includes the structure, hardware, and components as illustrated for UE 115 of FIGS. 2 and/or 4. For example, UE 115 includes controller/processor 280, which operates to execute logic or computer instructions stored in memory 282, as well as controlling the components of UE 115 that provide the features and functionality of UE 115. UE 115, under control of controller/processor 280, transmits and receives signals via wireless radios 1601a-r and antennas 252a-r. Wireless radios 1601a-r includes various components and hardware, as illustrated in FIG. 2 for UE 115, including modulator/demodulators 254a-r, MIMO detector 256, receive processor 258, transmit processor 264, and TX MIMO processor 266. As illustrated in the example of FIG. 16, memory 282 stores maximum resource element logic 1602, resource element mapping logic 1603, broadcast logic 1604, scheduling information data 1605, timing information data 1606, resource configuration data 1607, and settings data 1608. The data (1602-1608) stored in the memory 282 may include or correspond to the data (406, 408, 442, and/or 444) stored in the memory 404 of FIG. 4.

At block 1200, a wireless communication device, such as a UE, receives scheduling information in accordance with a first maximum quantity of resources. The first maximum quantity is based on a first channel bandwidth, first frequency band information, and a first subcarrier spacing (SCS), and the first frequency band information is indicative of a first type of frequency band or a first frequency band. For example, the UE (e.g., UE 115) may receive the scheduling information from another device (e.g., a base station 105 or a second UE 115). As described above, the scheduling information may include or correspond to configuration information (e.g., channel configuration information), timing information, or both. Alternatively, the scheduling information may include or correspond to resource configuration information (e.g. a table or other data structure) which indicates or identifies maximum quantities for different combinations of channel bandwidth, SCS, and frequency band. Additionally, the scheduling information may indicate or identify a resource element allocation, such as by starting RE and number of consecutive REs (e.g., Type 1 allocation) or by indication or a RE group or groups (e.g., Type 0 allocation). The scheduling information may be received in one or multiple messages. The message or messages may include or correspond to different type and/or combination of measurements.

The scheduling information may be received in a transmission or message that includes or include or correspond to the configuration transmission 450 or the configuration message 452, and/or the signaling message 454 of FIG. 4. To illustrate, a receiver (e.g., receiver processor 258 or receiver 412) of the UE 115 receives the configuration message 452 and the signaling message 454 from the base station 105 via wireless radios 1601a-r and antennas 252a-r which each includes at least a portion of the scheduling information. As other examples, scheduling information may be received in a transmission or message that includes or include or correspond to the configuration transmissions and/or signaling transmission as described with reference to FIGS. 5-7.

The timing information may include time and/or frequency information for transmission resources. For example, the timing information may include frequency domain resource assignment information and correspond to a frequency domain resource assignment or include timing domain resource assignment information or correspond to a timing domain resource assignment.

At block 1201, the UE transmits or receives a first transmission in accordance with the scheduling information. For example, the UE may transmit or receive at least one transmission of the transmissions 456 to another UE, such as second UE 403, or to a network device, such as base station 105. The first transmission may include or correspond to one or more of the transmissions 456 of FIG. 4, or one or more of uplink or downlink transmissions, as described with reference to FIGS. 5-7.

When the UE receives the first transmission, the UE 115 may receive, based on the scheduling information, a downlink transmission or a sidelink transmission. To illustrate, a receiver (e.g., receiver processor 258 or receiver 412) of the UE 115 receives the first transmission 456 via wireless radios 1601a-r and antennas 252a-r which is in accordance with the first maximum quantity of resources.

When the UE transmits the first transmission, the UE 115 may transmit, based on the scheduling information, an uplink transmission or a sidelink transmission. To illustrate, a transmitter (e.g., transmit processor 264 or transmitter 410) of the UE 115 transmits the first transmission 456 via wireless radios 1601a-r and antennas 252a-r which is in accordance with the first maximum quantity of resources.

The wireless communication device (e.g., UE or base station) may execute additional blocks (or the wireless communication device may be configured further perform additional operations) in other implementations. For example, the wireless communication device (e.g., the UE 115) may perform one or more operations described above, such as described with reference to FIGS. 4-7. As another example, the wireless communication device (e.g., the UE 115) may perform one or more aspects as presented below.

In first aspect, the wireless network node (e.g., the UE, such as the processor thereof) is further configured to receive second scheduling information in accordance with a second maximum quantity of resources, wherein the second maximum quantity is based on the first channel bandwidth, second frequency band information, and the first SCS, wherein the second frequency band information is indicative of a second type of frequency band or a second frequency band, wherein the second maximum quantity of resources is different from the first maximum quantity of resources, and wherein the second frequency band information is different from the first frequency band information; and transmit or receive a second transmission in accordance with the second scheduling information.

In a second aspect, alone or in combination with one or more of the above aspects, the first type of frequency band is an ultra high frequency (UHF) band type, and the second type of a frequency band is different from the UHF band type.

In a third aspect, alone or in combination with one or more of the above aspects, the first type of frequency band or the first frequency band corresponds to a frequency spectrum below 7.125 GHz, and wherein the second type of frequency band or the second frequency band corresponds to a frequency spectrum above 24.250 GHz.

In a fourth aspect, alone or in combination with one or more of the above aspects, the first type of frequency band or the first frequency band corresponds to a UHF spectrum or a spectrum above the UHF spectrum, and wherein the second type of frequency band or the second frequency band corresponds to a spectrum below the UHF spectrum.

In a fifth aspect, alone or in combination with one or more of the above aspects, the first type of frequency band is UHF band type or different from the UHF band type.

In a sixth aspect, alone or in combination with one or more of the above aspects, the first type of frequency band or the first frequency band corresponds to a UHF spectrum.

In a seventh aspect, alone or in combination with one or more of the above aspects, a first out of band emission (OOBE) condition associated with the first type of frequency band is different from a second OOBE condition associated with the second type of frequency band; a first adjacent channel leakage ratio (ALCR) condition associated with the first type of frequency band is different from a second ALCR condition associated with the second type of frequency band; or both.

In an eighth aspect, alone or in combination with one or more of the above aspects, the first transmission has first spectral efficiency which is greater than a second spectral efficiency of the second transmission.

In a ninth aspect, alone or in combination with one or more of the above aspects, the first type of frequency band corresponds to a first frequency spectrum, wherein the second type of frequency band corresponds to a second frequency spectrum, wherein a first spectral emission mask (SEM) associated with the first frequency spectrum is different from a second SEM associated with the second frequency spectrum.

In a tenth aspect, alone or in combination with one or more of the above aspects, the first transmission is within a first frequency spectrum, and wherein the at least one processor is configured to: operate in a second frequency spectrum at least partially concurrently with the first transmission in the first frequency spectrum, wherein the first frequency spectrum is UHF, VHF, satellite, or cellular spectrum, and the second frequency spectrum is another of UHF, VHF, satellite, or cellular spectrum.

In an eleventh aspect, alone or in combination with one or more of the above aspects, the at least one processor is configured to: determine the first channel bandwidth based on the first frequency band information and the first SCS.

In a twelfth aspect, alone or in combination with one or more of the above aspects, the scheduling information includes information indicative of the first channel bandwidth, the first frequency band information, and the first SCS.

In a thirteenth aspect, alone or in combination with one or more of the above aspects, to receive the scheduling information, the at least one processor is configured to: receive radio resource control (RRC) signaling, wherein the RRC signaling includes information indicative of the first channel bandwidth, the first frequency band information, and the first SCS; and receive downlink control information including timing information for the first transmission, wherein the timing information is indicative of a starting resource and a quantity of resources for the first transmission.

In a fourteenth aspect, alone or in combination with one or more of the above aspects, the scheduling information includes information indicative of the first channel bandwidth, the first frequency band information, and the first SCS, and wherein the at least one processor is configured to: determine the first maximum quantity of resources based on of the first channel bandwidth, the first frequency band information, and the first SCS.

In a fifteenth aspect, alone or in combination with one or more of the above aspects, the at least one processor is configured to receive resource configuration information, wherein the resource configuration information includes information indicative of: the first maximum quantity of resources corresponding to the first frequency band information, the first channel bandwidth, and the first SCS; and a second maximum quantity of resources corresponding to second frequency band information, the first channel bandwidth, and the first SCS, wherein the second frequency band information is indicative of a second type of frequency band or a second frequency band, wherein the second maximum quantity of resources is different from the first maximum quantity of resources, and wherein the second frequency band information is different from the first frequency band information.

In a sixteenth aspect, alone or in combination with one or more of the above aspects, the first type of frequency band is a UHF band type, and the second type of a frequency band is different from the UHF band type.

In an seventeenth aspect, alone or in combination with one or more of the above aspects, the first type of frequency band or the first frequency band corresponds to a frequency spectrum below 7.125 GHz, and wherein the second type of frequency band or the second frequency band corresponds to a frequency spectrum above 24.250 GHz.

In an eighteenth aspect, alone or in combination with one or more of the above aspects, the first type of frequency band or the first frequency band corresponds to a UHF spectrum or a spectrum above the UHF spectrum, and wherein the second type of frequency band or the second frequency band corresponds to a spectrum below the UHF spectrum.

In a nineteenth aspect, alone or in combination with one or more of the above aspects, the memory has the resource configuration information stored thereon, and wherein, to determine the first maximum quantity of resources, the at least one processor is configured to access the resource configuration information stored on the memory.

In a twentieth aspect, alone or in combination with one or more of the above aspects, the resources comprise physical layer resource units.

In a twenty-first aspect, alone or in combination with one or more of the above aspects, the resources comprise resource blocks (RBs).

Accordingly, wireless communication devices may perform improved spectrum utilization operations for wireless communication devices. By performing improved spectrum utilization, throughput can be increased and latency can be reduced.

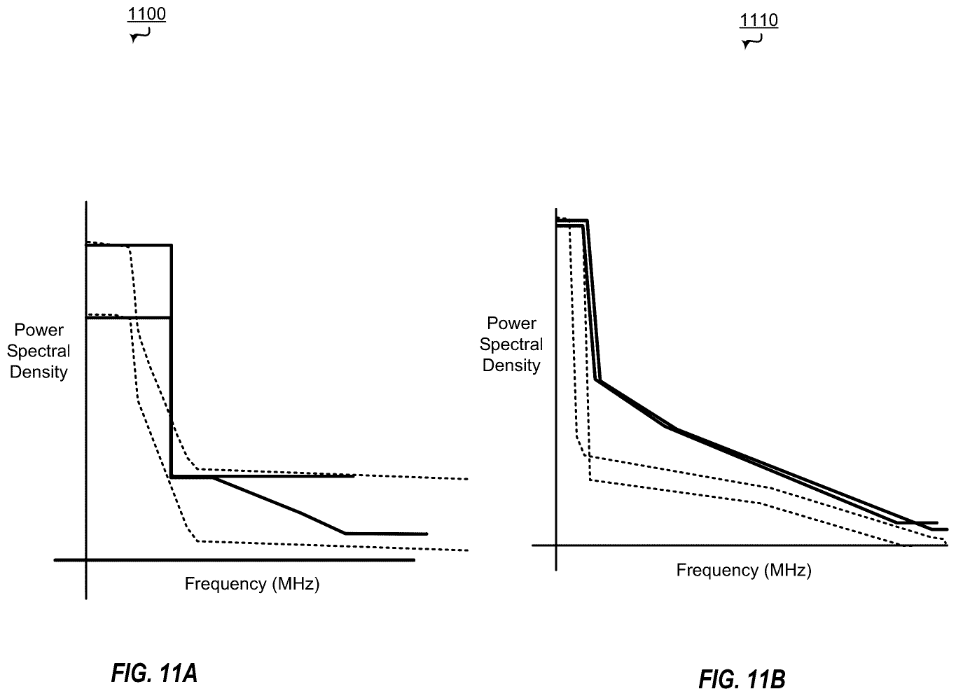

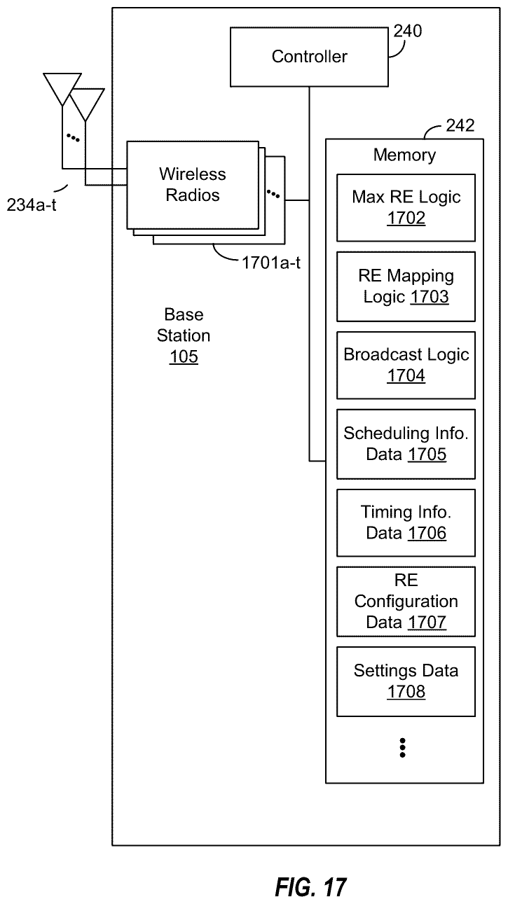

FIG. 13 is a flow diagram illustrating example blocks executed wireless communication device (e.g., a UE or network entity, such as a base station) configured according to an aspect of the present disclosure. The example blocks will also be described with respect to base station 105 as illustrated in FIG. 17. FIG. 17 is a block diagram illustrating base station 105 configured according to one aspect of the present disclosure. Base station 105 includes the structure, hardware, and components as illustrated for base station 105 of FIGS. 2 and/or 4. For example, base station 105 includes controller/processor 240, which operates to execute logic or computer instructions stored in memory 242, as well as controlling the components of base station 105 that provide the features and functionality of base station 105. Base station 105, under control of controller/processor 240, transmits and receives signals via wireless radios 1701a-t and antennas 234a-t. Wireless radios 1701a-t includes various components and hardware, as illustrated in FIG. 2 for base station 105, including modulator/demodulators 232a-r, MIMO detector 236, receive processor 238, transmit processor 220, and TX MIMO processor 230. As illustrated in the example of FIG. 17, memory 242 stores maximum resource element logic 1702, resource element mapping logic 1703, broadcast logic 1704, scheduling information data 1705, timing information data 1706, resource configuration data 1707, and settings data 1708. The data (1702-1708) stored in the memory 242 may include or correspond to the data (406, 408, 442, and/or 444) stored in the memory 432 of FIG. 4.

At block 1300, a wireless communication device, such as a network device (e.g., a base station 105), transmits scheduling information in accordance with a first maximum quantity of resources. The first maximum quantity is based on a first channel bandwidth, first frequency band information, and a first subcarrier spacing (SCS), and the first frequency band information is indicative of a first type of frequency band or a first frequency band. For example, the base station 105 may transmit the scheduling information to one or more UEs (e.g., the UE 115 and/or the second UE 403). As described above, the scheduling information may include or correspond to configuration information (e.g., channel configuration information), timing information, or both.

Alternatively, the scheduling information may include or correspond to resource configuration information (e.g. a table or other data structure) which indicates or identifies maximum quantities for different combinations of channel bandwidth, SCS, and frequency band. Additionally, the scheduling information may indicate or identify a resource element allocation, such as by starting RE and number of consecutive REs (e.g., Type 1 allocation) or by indication or a RE group or groups (e.g., Type 0 allocation). The scheduling information may be received in one or multiple messages. The message or messages may include or correspond to different type and/or combination of measurements.

The scheduling information may be transmitted in a transmission or message that includes or include or correspond to the configuration transmission 450 or the configuration message 452, and/or the signaling message 454 of FIG. 4. To illustrate, a transmitter (e.g., transmit processor 220/TX MIMO processor 230 or transmitter 434) of the base station 105 transmits the configuration message 452 and the signaling message 454 via wireless radios 1701a-t and antennas 234a-t which each includes at least a portion of the scheduling information. As other examples, scheduling information may be transmitted in a transmission or message that includes or include or correspond to the configuration transmissions and/or signaling transmission as described with reference to FIGS. 5-7.

At block 1301, the wireless communication device transmits or receives a first transmission in accordance with the scheduling information. For example, the base station 105 may transmit or receive at least one transmission of the transmissions 456 to one or more UEs (e.g., UE 115 and/or second UE 403). The first transmission may include or correspond to one or more of the transmissions 456 of FIG. 4, or one or more of uplink or downlink transmissions, as described with reference to FIGS. 5-7.

When the base station 105 receives the first transmission, the base station 105 may receive, based on the scheduling information, a downlink transmission or a sidelink transmission. To illustrate, a receiver (e.g., receiver processor 238 or receiver 436) of the base station 105 receives the first transmission 456 via wireless radios 1701a-t and antennas 234a-t which is in accordance with the first maximum quantity of resources.

When the base station 105 transmits the first transmission, the base station 105 may transmit, based on the scheduling information, an uplink transmission or a sidelink transmission. To illustrate, a transmitter (e.g., transmit processor 220/TX MIMO processor 230 or transmitter 434) of the base station 105 transmits the first transmission 456 via wireless radios 1701a-t and antennas 234a-t which is in accordance with the first maximum quantity of resources. receives the first transmission 456 in resource elements or blocks identified based on the starting resource and the quantity of resources.

The wireless communication device (e.g., such as a UE or base station) may execute additional blocks (or the wireless communication device may be configured further perform additional operations) in other implementations. For example, the wireless communication device may perform one or more operations as described with reference to FIGS. 4-7. As another example, the wireless communication device may perform one or more aspects as described above with reference to FIG. 12.

Accordingly, wireless communication devices may perform improved spectrum utilization operations for wireless communication devices. By performing improved spectrum utilization, throughput can be increased and latency can be reduced.

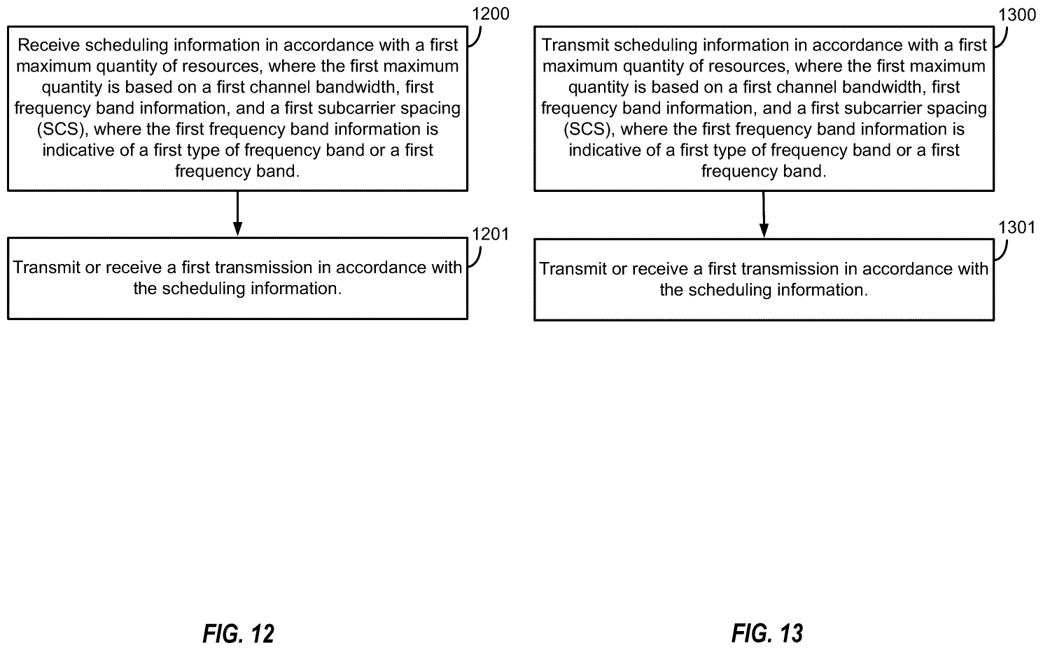

FIG. 14 is a flow diagram illustrating example blocks executed wireless communication device (e.g., a UE or network entity, such as a base station) configured according to an aspect of the present disclosure. The example blocks will also be described with respect to UE 115 as illustrated in FIG. 16 and described above.

At block 1400, a wireless communication device, such as a network device (e.g., a base station 105), receives scheduling information indicative of a first channel bandwidth, first frequency band information, a first subcarrier spacing (SCS), a starting resource, and a quantity of resources for a first transmission, where the first frequency band information is indicative of a first type of frequency band or a first frequency band. For example, the UE (e.g., UE 115) may receive the scheduling information from another device (e.g., a base station 105 or a UE 115). As described above, the scheduling information may include or correspond to configuration information (e.g., channel configuration information), timing information, or both. The scheduling information may indicate or identify a resource element allocation, such as by starting RE and number of consecutive REs (e.g., Type 1 allocation) or by indication or a RE group or groups (e.g., Type 0 allocation). The scheduling information may be received in one or multiple messages. The message or messages may include or correspond to different type and/or combination of measurements.

The scheduling information may be received in a transmission or message that includes or include or correspond to the configuration transmission 450 or the configuration message 452, and/or the signaling message 454 of FIG. 4. To illustrate, a receiver (e.g., receiver processor 258 or receiver 412) of the UE 115 receives the configuration message 452 and the signaling message 454 from the base station 105 via wireless radios 1601a-r and antennas 252a-r which each includes at least a portion of the scheduling information. As other examples, scheduling information may be received in a transmission or message that includes or include or correspond to the configuration transmissions and/or signaling transmission as described with reference to FIGS. 5-7.

The scheduling information may further include time and/or frequency information for transmission resources. For example, the scheduling information may include frequency domain resource assignment information and correspond to a frequency domain resource assignment or include timing domain resource assignment information or correspond to a timing domain resource assignment.

At block 1401, the wireless communication device transmits or receives, based on the starting resource and the quantity of resources, the first transmission in a set of resources of a first maximum quantity of resources, where the first maximum quantity of resources is based on the first channel bandwidth, the first frequency band information, and the first SCS. For example, the UE 115 may transmit or receive at least one transmission of the transmissions 456 to another UE, such as second UE 403, or to a network device, such as base station 105, in a subset of resources of a maximum quantity of resources where the subset of resources is identified based on the starting resource and the quantity of resources and the maximum quantity of resources is based on the first channel bandwidth, the first frequency band information, and the first SCS. The first transmission may include or correspond to one or more of the transmissions 456 of FIG. 4, or one or more of uplink or downlink transmissions, as described with reference to FIGS. 5-7.

The wireless communication device (e.g., UE or base station) may execute additional blocks (or the wireless communication device may be configured further perform additional operations) in other implementations. For example, the wireless communication device (e.g., the UE 115) may perform one or more operations described above, such as described with reference to FIGS. 4-7. As another example, the wireless communication device (e.g., the UE 115) may perform one or more aspects as presented with respect to FIG. 12 or below.

When the UE receives the first transmission, the UE 115 may receive, based on the starting resource and the quantity of resources, a downlink transmission or a sidelink transmission. To illustrate, a receiver (e.g., receiver processor 258 or receiver 412) of the UE 115 receives the first transmission 456 via wireless radios 1601a-r and antennas 252a-r in resource elements or blocks identified based on the starting resource and the quantity of resources.

When the UE transmits the first transmission, the UE 115 may transmit, based on the starting resource and the quantity of resources, an uplink transmission or a sidelink transmission. To illustrate, a transmitter (e.g., transmit processor 264 or transmitter 410) of the UE 115 transmits the first transmission 456 via wireless radios 1601a-r and antennas 252a-r in resource elements or blocks identified based on the starting resource and the quantity of resources. As indicated above, the starting resource and the quantity of resources may be indicated by Type 0 indication (e.g., using RB groups) or by Type 1 allocation (RIV).

In a first aspect, the scheduling information is received in a single transmission.

In a second aspect, alone or in combination with one or more of the above aspects, the single transmission corresponds to a radio resource control (RRC), downlink control information, a physical downlink control channel PDCCH), or a medium access control control element (MAC CE).

In a third aspect, alone or in combination with one or more of the above aspects, the first transmission corresponds to broadcast transmission.

In a fourth aspect, alone or in combination with one or more of the above aspects, the broadcast transmission corresponds to Cell Acquisition Subframes (CAS) or Multicast Broadcast Service (MBS) data transmitted in a Physical Multicast Channel (PMCH).

In a fifth aspect, alone or in combination with one or more of the above aspects, a portion of the scheduling information is indicated in a Cell Acquisition Subframes (CAS) of a broadcast transmission, a system information block (SIB) transmission, a multicast control channel (MCCH) transmission, or in a MBSFNAreaInfo information element.

In a sixth aspect, alone or in combination with one or more of the above aspects, the scheduling information is received over multiple transmissions.

In a seventh aspect, alone or in combination with one or more of the above aspects, the scheduling information includes configuration information and timing information, and wherein, to receive the scheduling information, the at least one processor is configured to: receive a first signaling transmission including the configuration information indicative of the first channel bandwidth, the first frequency band information, and the first SCS for the first transmission; and receive a second signaling transmission including the timing information indicative of the starting resource and the quantity of resources for the first transmission.

In an eighth aspect, alone or in combination with one or more of the above aspects, the first signaling transmission corresponds to radio resource control (RRC) signaling or a medium access control control element (MAC CE), and wherein the second signaling transmission corresponds to downlink control information, a physical downlink control channel PDCCH), or the MAC CE.

In a tenth aspect, alone or in combination with one or more of the above aspects, the timing information corresponds to a resource indicator value (RIV), and wherein the at least one processor is configured to determine the starting resource and the quantity of resources for the first transmission based on the RIV.

In an eleventh aspect, alone or in combination with one or more of the above aspects, the at least one processor is configured to: receive second scheduling information indicative of the first channel bandwidth, second frequency band information, the first SCS, a second starting resource, and a second quantity of resources for a second transmission, wherein the second frequency band information is indicative of a second type of frequency band or a second frequency band; and transmit or receive, based on the second starting resource and the second quantity of resources, the second transmission in a second set of resources of a second maximum quantity of resources, wherein the second maximum quantity of resources is based on the first channel bandwidth, the second frequency band information, and the first SCS, and wherein the second maximum quantity of resources is different from the first maximum quantity of resources, and wherein the second frequency band information is different from the first frequency band information.

In a twelfth aspect, alone or in combination with one or more of the above aspects, the first type of frequency band is an ultra high frequency (UHF) band type, and the second type of a frequency band is different from the UHF band type.

In a thirteenth aspect, alone or in combination with one or more of the above aspects, the first type of frequency band or the first frequency band corresponds to a frequency spectrum below 7.125 GHz, and wherein the second type of frequency band or the second frequency band corresponds to a frequency spectrum above 24.250 GHz.

In a fourteenth aspect, alone or in combination with one or more of the above aspects, the first type of frequency band or the first frequency band corresponds to a UHF spectrum or a spectrum above the UHF spectrum, and wherein the second type of frequency band or the second frequency band corresponds to a spectrum below the UHF spectrum.

In a fifteenth aspect, alone or in combination with one or more of the above aspects, the first type of frequency band is UHF band type or different from the UHF band type.

In a sixteenth aspect, alone or in combination with one or more of the above aspects, the first type of frequency band or the first frequency band corresponds to a UHF spectrum.

In a seventeenth aspect, alone or in combination with one or more of the above aspects,
a first out of band emission (OOBE) condition associated with the first type of frequency band is different from a second OOBE condition associated with the second type of frequency band; a first adjacent channel leakage ratio (ALCR) condition associated with the first type of frequency band is different from a second ALCR condition associated with the second type of frequency band; or both.

In an eighteenth aspect, alone or in combination with one or more of the above aspects, the e first transmission has first spectral efficiency which is greater than a second spectral efficiency of the second transmission.

In a nineteenth aspect, alone or in combination with one or more of the above aspects, the first type of frequency band corresponds to a first frequency spectrum, wherein the second type of frequency band corresponds to a second frequency spectrum, wherein a first spectral emission mask (SEM) associated with the first frequency spectrum is different from a second SEM associated with the second frequency spectrum.

In a twentieth aspect, alone or in combination with one or more of the above aspects, the first transmission is within a first frequency spectrum, and wherein the at least one processor is configured to: operate in a second frequency spectrum at least partially concurrently with the first transmission in the first frequency spectrum, wherein the first frequency spectrum is UHF, VHF, satellite, or cellular spectrum, and the second frequency spectrum is another of UHF, VHF, satellite, or cellular spectrum.

In a twenty-first aspect, alone or in combination with one or more of the above aspects, the at least one processor is configured to: determine the first channel bandwidth based on the first frequency band information and the first SCS.

In a twenty-second aspect, alone or in combination with one or more of the above aspects, the resources comprise physical layer resource units.

In a twenty-third aspect, alone or in combination with one or more of the above aspects, the resources comprise resource blocks (RBs).

In another aspect, a network node for wireless communication, comprising: at least one processor; and a memory coupled to the at least one processor, wherein the at least one processor is configured to: transmit scheduling information indicative of a first channel bandwidth, first frequency band information, a first subcarrier spacing (SCS), a starting resource, and a quantity of resources for a first transmission, wherein the first frequency band information is indicative of a first type of frequency band or a first frequency band; and transmit or receive, based on the starting resource and the quantity of resources, the first transmission in a set of resources of a first maximum quantity of resources, wherein the first maximum quantity of resources is based on the first channel bandwidth, the first frequency band information, and the first SCS.

In another aspect, a network node for wireless communication, comprising: at least one processor; and a memory coupled to the at least one processor, wherein the at least one processor is configured to: receive resource configuration information indicating a first maximum quantity of resources corresponding to first frequency band information, a first channel bandwidth, and a first SCS, and indicating a second maximum quantity of resources corresponding to second frequency band information, the first channel bandwidth, and the first SCS, wherein the second maximum quantity of resources is different from the first maximum quantity of resources, and wherein the second frequency band information is different from the first frequency band information; and transmit or receive a first transmission in accordance with the first maximum quantity of resources, the first channel bandwidth, the first frequency band information, and the first SCS.

In a first aspect, alone or in combination with one or more of the above aspects, the at least one processor is configured to: transmit or receive a second transmission in accordance with the second maximum quantity of resources, the first channel bandwidth, the second frequency band information, and the first SCS.

In another aspect, a network node for wireless communication, comprising: at least one processor; and a memory coupled to the at least one processor, wherein the at least one processor is configured to: transmit resource configuration information indicating a first maximum quantity of resources corresponding to first frequency band information, a first channel bandwidth, and a first SCS, and indicating a second maximum quantity of resources corresponding to second frequency band information, the first channel bandwidth, and the first SCS, wherein the second maximum quantity of resources is different from the first maximum quantity of resources, and wherein the second frequency band information is different from the first frequency band information; and transmit or receive a first transmission in accordance with the first maximum quantity of resources, the first channel bandwidth, the first frequency band information, and the first SCS.

In a first aspect, alone or in combination with one or more of the above aspects, the at least one processor is configured to: transmit or receive a second transmission in accordance with the second maximum quantity of resources, the first channel bandwidth, the second frequency band information, and the first SCS.

In a second aspect, alone or in combination with one or more of the above aspects, the resource configuration information corresponds to: a first data structure including the first maximum quantity of resources corresponding to the first frequency band information, the first channel bandwidth, and the first SCS; and a second data structure including the second maximum quantity of resources corresponding to the second frequency band information, the first channel bandwidth, and the first SCS.

In a third aspect, alone or in combination with one or more of the above aspects, the resource configuration information corresponds to a data structure including: the first maximum quantity of resources corresponding to the first frequency band information, the first channel bandwidth, and the first SCS; and the second maximum quantity of resources corresponding to the second frequency band information, the first channel bandwidth, and the first SCS.

Accordingly, wireless communication devices may perform improved spectrum utilization operations for wireless communication devices. By performing improved spectrum utilization, throughput can be increased and latency can be reduced.

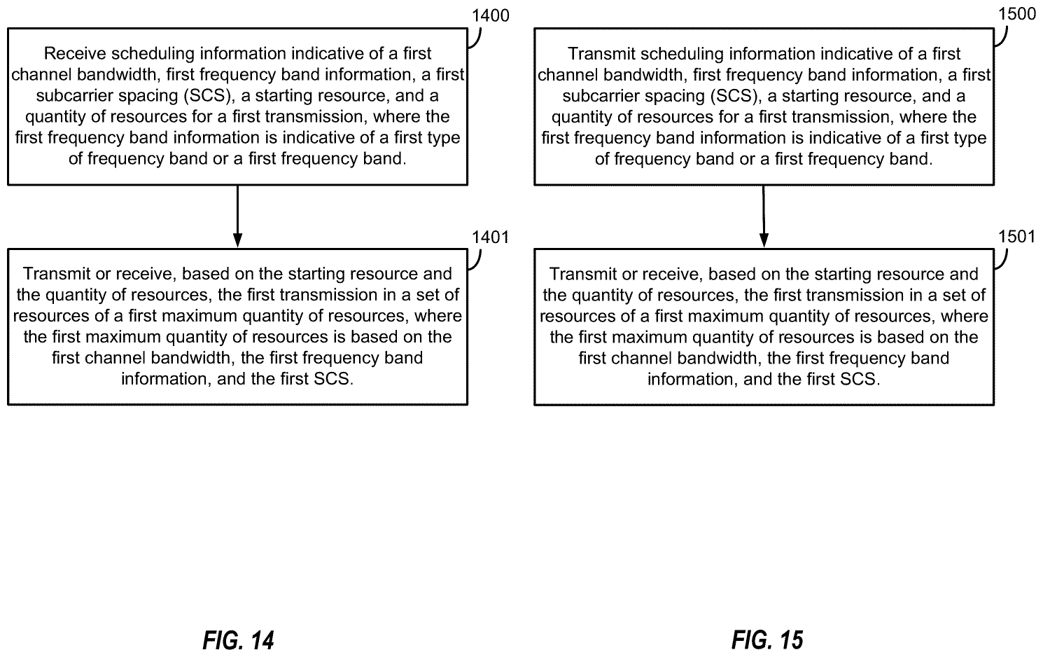

FIG. 15 is a flow diagram illustrating example blocks executed wireless communication device (e.g., a UE or network entity, such as a base station) configured according to an aspect of the present disclosure. The example blocks will also be described with respect to base station 105 as illustrated in FIG. 17.

At block 1500, a wireless communication device, such as a network device (e.g., a base station 105), transmits scheduling information indicative of a first channel bandwidth, first frequency band information, a first subcarrier spacing (SCS), a starting resource, and a quantity of resources for a first transmission, where the first frequency band information is indicative of a first type of frequency band or a first frequency band. For example, the base station 105 may transmit the scheduling information to one or more UEs (e.g., UE 115 and/or second UE 403). As described above, the scheduling information may include or correspond to configuration information (e.g., channel configuration information), timing information, or both. The scheduling information may indicate or identify a resource element allocation, such as by starting RE and number of consecutive REs (e.g., Type 1 allocation) or by indication or a RE group or groups (e.g., Type 0 allocation). The scheduling information may be received in one or multiple messages. The message or messages may include or correspond to different type and/or combination of measurements.

The scheduling information may be transmitted in a transmission or message that includes or include or correspond to the configuration transmission 450 or the configuration message 452, and/or the signaling message 454 of FIG. 4. To illustrate, a transmitter (e.g., transmit processor 220/TX MIMO processor 230 or transmitter 434) of the base station 105 transmits the configuration message 452 and the signaling message 454 via wireless radios 1701a-t and antennas 234a-t which each includes at least a portion of the scheduling information. As other examples, scheduling information may be received in a transmission or message that includes or include or correspond to the configuration transmissions and/or signaling transmission as described with reference to FIGS. 5-7.

At block 1501, the wireless communication device transmits or receives, based on the starting resource and the quantity of resources, the first transmission in a set of resources of a first maximum quantity of resources, where the first maximum quantity of resources is based on the first channel bandwidth, the first frequency band information, and the first SCS. For example, the base station 105 may transmit or receive at least one transmission of the transmissions 456 to one or more UEs, such as UE 115 or second UE 403, in a subset of resources of a maximum quantity of resources where the subset of resources is identified based on the starting resource and the quantity of resources and the maximum quantity of resources is based on the first channel bandwidth, the first frequency band information, and the first SCS. The first transmission may include or correspond to one or more of the transmissions 456 of FIG. 4, or one or more of uplink or downlink transmissions, as described with reference to FIGS. 5-7.

When the base station receives the first transmission, the base station 105 may receive, based on the starting resource and the quantity of resources, a downlink transmission or a sidelink transmission. To illustrate, a receiver (e.g., receiver processor 238 or receiver 436) of the base station 105 receives the first transmission 456 via wireless radios 1701a-t and antennas 234a-t in resource elements or blocks identified based on the starting resource and the quantity of resources.

When the base station transmits the first transmission, the base station 105 may transmit, based on the starting resource and the quantity of resources, an uplink transmission or a sidelink transmission. To illustrate, a transmitter (e.g., transmit processor 220/TX MIMO processor 230 or transmitter 434) of the base station 105 transmits the first transmission 456 via wireless radios 1701a-t and antennas 234a-t in resource elements or blocks identified based on the starting resource and the quantity of resources. As indicated above, the starting resource and the quantity of resources may be indicated by Type 0 indication (e.g., using RB groups) or by Type 1 allocation (RIV).

The wireless communication device (e.g., such as a UE or base station) may execute additional blocks (or the wireless communication device may be configured further perform additional operations) in other implementations. For example, the wireless communication device may perform one or more operations as described with reference to FIGS. 4-7. As another example, the wireless communication device may perform one or more aspects as described above with respect to FIG. 14.

Accordingly, wireless communication devices may perform improved spectrum utilization operations for wireless communication devices. By performing improved spectrum utilization, throughput can be increased and latency can be reduced.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-17 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, the term “or” is an inclusive “or” unless limiting language is used relative to the alternatives listed. For example, reference to “X being based on A or B” shall be construed as including within its scope X being based on A, X being based on B, and X being based on A and B. In this regard, reference to “X being based on A or B” refers to “at least one of A or B” or “one or more of A or B” due to “or” being inclusive. Similarly, reference to “X being based on A, B, or C” shall be construed as including within its scope X being based on A, X being based on B, X being based on C, X being based on A and B, X being based on A and C, X being based on B and C, and X being based on A, B, and C. In this regard, reference to “X being based on A, B, or C” refers to “at least one of A, B, or C” or “one or more of A, B, or C” due to “or” being inclusive. As an example of limiting language, reference to “X being based on only one of A or B” shall be construed as including within its scope X being based on A as well as X being based on B, but not X being based on A and B. Also, as used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently. Also, as used herein, the phrase “a set” shall be construed as including the possibility of a set with one member. That is, the phrase “a set” shall be construed in the same manner as “one or more” or “at least one of.”

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A network node for wireless communication, comprising:
at least one processor; and
a memory coupled to the at least one processor,
wherein the at least one processor is configured to:
receive scheduling information in accordance with a first maximum quantity of resources, wherein the first maximum quantity is based on a first channel bandwidth, first frequency band information, and a first subcarrier spacing (SCS), wherein the first frequency band information is indicative of a first type of frequency band or a first frequency band; and
transmit or receive a first transmission in accordance with the scheduling information.

2. The network node of claim 1, wherein the at least one processor is configured to:
receive second scheduling information in accordance with a second maximum quantity of resources, wherein the second maximum quantity is based on the first channel bandwidth, second frequency band information, and the first SCS, wherein the second frequency band information is indicative of a second type of frequency band or a second frequency band, wherein the second maximum quantity of resources is different from the first maximum quantity of resources, and wherein the second frequency band information is different from the first frequency band information; and
transmit or receive a second transmission in accordance with the second scheduling information.

3. The network node of claim 2, wherein the first type of frequency band is an ultra high frequency (UHF) band type, and the second type of a frequency band is different from the UHF band type.

4. The network node of claim 2, wherein the first type of frequency band or the first frequency band corresponds to a frequency spectrum below 7.125 GHz, and wherein the second type of frequency band or the second frequency band corresponds to a frequency spectrum above 24.250 GHz.

5. The network node of claim 2, wherein the first type of frequency band or the first frequency band corresponds to a UHF spectrum or a spectrum above the UHF spectrum, and wherein the second type of frequency band or the second frequency band corresponds to a spectrum below the UHF spectrum.

6. The network node of claim 2, wherein the first type of frequency band is UHF band type or different from the UHF band type.

7. The network node of claim 2, wherein the first type of frequency band or the first frequency band corresponds to a UHF spectrum.

8. The network node of claim 2, wherein:
a first out of band emission (OOBE) condition associated with the first type of frequency band is different from a second OOBE condition associated with the second type of frequency band;
a first adjacent channel leakage ratio (ALCR) condition associated with the first type of frequency band is different from a second ALCR condition associated with the second type of frequency band; or
both.

9. The network node of claim 2, wherein the first transmission has first spectral efficiency which is greater than a second spectral efficiency of the second transmission.

10. The network node of claim 2, wherein the first type of frequency band corresponds to a first frequency spectrum, wherein the second type of frequency band corresponds to a second frequency spectrum, wherein a first spectral emission mask (SEM) associated with the first frequency spectrum is different from a second SEM associated with the second frequency spectrum.

11. The network node of claim 2, wherein the first transmission is within a first frequency spectrum, and wherein the at least one processor is configured to:
operate in a second frequency spectrum at least partially concurrently with the first transmission in the first frequency spectrum, wherein the first frequency spectrum is UHF, VHF, satellite, or cellular spectrum, and the second frequency spectrum is another of UHF, VHF, satellite, or cellular spectrum.

12. The network node of claim 1, wherein the at least one processor is configured to:
determine the first channel bandwidth based on the first frequency band information and the first SCS.

13. The network node of claim 1, wherein the scheduling information includes information indicative of the first channel bandwidth, the first frequency band information, and the first SCS.

14. The network node of claim 1, wherein, to receive the scheduling information, the at least one processor is configured to:
receive radio resource control (RRC) signaling, wherein the RRC signaling includes information indicative of the first channel bandwidth, the first frequency band information, and the first SCS; and
receive downlink control information including timing information for the first transmission, wherein the timing information is indicative of a starting resource and a quantity of resources for the first transmission.

15. The network node of claim 1, wherein, to receive the scheduling information, the at least one processor is configured to:
receive a signaling message indicative of the first channel bandwidth, the first frequency band information, and the first SCS.

16. The network node of claim 1, wherein the resources comprise physical layer resource units.

17. The network node of claim 1, wherein the resources comprise resource blocks (RBs).

18. A network node for wireless communication, comprising:
at least one processor; and
a memory coupled to the at least one processor,
wherein the at least one processor is configured to:
transmit scheduling information in accordance with a first maximum quantity of resources, wherein the first maximum quantity is based on a first channel bandwidth, first frequency band information, and a first subcarrier spacing (SCS), wherein the first frequency band information is indicative of a first type of frequency band or a first frequency band; and
transmit or receive a first transmission in accordance with the scheduling information.

19. A network node for wireless communication, comprising:
at least one processor; and
a memory coupled to the at least one processor,
wherein the at least one processor is configured to:
receive scheduling information indicative of a first channel bandwidth, first frequency band information, a first subcarrier spacing (SCS), a starting resource, and a quantity of resources for a first transmission, wherein the first frequency band information is indicative of a first type of frequency band or a first frequency band; and
transmit or receive, based on the starting resource and the quantity of resources, the first transmission in a set of resources of a first maximum quantity of resources, wherein the first maximum quantity of resources is based on the first channel bandwidth, the first frequency band information, and the first SCS.

20. The network node of claim 19, wherein the scheduling information is received in a single transmission.

21. The network node of claim 20, wherein the single transmission corresponds to a radio resource control (RRC), downlink control information, a physical downlink control channel PDCCH), or a medium access control control element (MAC CE).

22. The network node of claim 19, wherein the first transmission corresponds to broadcast transmission.

23. The network node of claim 22, wherein the broadcast transmission corresponds to Cell Acquisition Subframes (CAS) or Multicast Broadcast Service (MBS) data transmitted in a Physical Multicast Channel (PMCH).

24. The network node of claim 19, wherein a portion of the scheduling information is indicated in a Cell Acquisition Subframes (CAS) of a broadcast transmission, a system information block (SIB) transmission, a multicast control channel (MCCH) transmission, or in a MBSFNAreaInfo information element.

25. The network node of claim 19, wherein the scheduling information is received over multiple transmissions.

26. The network node of claim 19, wherein the scheduling information includes configuration information and timing information, and wherein, to receive the scheduling information, the at least one processor is configured to:
receive a first signaling transmission including the configuration information indicative of the first channel bandwidth, the first frequency band information, and the first SCS for the first transmission; and
receive a second signaling transmission including the timing information indicative of the starting resource and the quantity of resources for the first transmission.

27. The network node of claim 26, wherein the first signaling transmission corresponds to radio resource control (RRC) signaling or a medium access control control element (MAC CE), and wherein the second signaling transmission corresponds to downlink control information, a physical downlink control channel PDCCH), or the MAC CE.

28. The network node of claim 26, wherein the timing information corresponds to a resource indicator value (RIV), and wherein the at least one processor is configured to determine the starting resource and the quantity of resources for the first transmission based on the RIV.

29. The network node of claim 19, wherein the at least one processor is configured to:
receive second scheduling information indicative of the first channel bandwidth, second frequency band information, the first SCS, a second starting resource, and a second quantity of resources for a second transmission, wherein the second frequency band information is indicative of a second type of frequency band or a second frequency band; and
transmit or receive, based on the second starting resource and the second quantity of resources, the second transmission in a second set of resources of a second maximum quantity of resources, wherein the second maximum quantity of resources is based on the first channel bandwidth, the second frequency band information, and the first SCS, and wherein the second maximum quantity of resources is different from the first maximum quantity of resources, and wherein the second frequency band information is different from the first frequency band information.

30. A network node for wireless communication, comprising:
at least one processor; and
a memory coupled to the at least one processor,
wherein the at least one processor is configured to:
transmit scheduling information indicative of a first channel bandwidth, first frequency band information, a first subcarrier spacing (SCS), a starting resource, and a quantity of resources for a first transmission, wherein the first frequency band information is indicative of a first type of frequency band or a first frequency band; and
transmit or receive, based on the starting resource and the quantity of resources, the first transmission in a set of resources of a first maximum quantity of resources, wherein the first maximum quantity of resources is based on the first channel bandwidth, the first frequency band information, and the first SCS.
